(19) United States
(12) Patent Application Publication
(10) Pub. No.: US 2025/0188227 A1
(43) Pub. Date: Jun. 12, 2025

(54) METHODS OF MAKING FREE-FLOWING PARTICLES HAVING A POLYMER MODIFIED SURFACE WHILE MAINTAINING THEIR PARTICLE SIZE

(71) Applicant: Beijing Oriental Yuhong Waterproof Technology Co. Ltd., Beijing (CN)

(72) Inventors: Willie Lau, Lower Gwynedd, PA (US); Wei Guo, Beijing (CN); Joseph Martin Rokowski, Barto, PA (US)

(73) Assignee: Beijing Oriental Yuhong Waterproof Technology Co. Ltd., Beijing (CN)

(21) Appl. No.: 18/531,206

(22) Filed: Dec. 6, 2023

(51) Int. Cl. C08J 3/12

(52) U.S. Cl. CPC C08J 3/124; C08J 2300/12

(57) ABSTRACT

The present invention provides simple methods of making free-flowing surface modified particles that enhance the functionality of surface modified particles containing them. The methods comprise treating finely divided dry or anhydrous particles, with an activator to form activated particles, mixing the activated particles with a stabilized aqueous composition comprising at least one polymer, such as one containing an additional ingredient, such as an antioxidant, an antimicrobial, an adhesion promoter, one or more colorants, one or more pigments, fillers or extenders, an abrasion resistant polymer, or a waterproofing agent to form a moist mixture; and, drying the moist mixture until it forms free-flowing surface modified particles, each particle having one or more discrete deposits of the polymer as solids on its surface.

The present invention relates to methods of treating a surface of finely divided particles having a sieve particle size of from 149 to 2000 μm with a stabilized aqueous composition comprising a polymer to form a plurality of free-flowing surface modified particles comprising surface modified particles at a high yield while avoiding agglomeration of the finely divided particles. More particularly, it relates to methods comprising treating a plurality of dry or anhydrous finely divided particles with an activator to form activated particles, mixing the activated particles with a stabilized aqueous composition comprising a polymer, such as one containing an anionically stabilized emulsion polymer, to form a moist mixture, and drying the moist mixture thereby crosslinking, coalescing or coagulating the polymer on the surface of the particles and forming surface modified, free-flowing finely divided particles having thereon discrete deposits of a solid polymer. The methods are useful to make durable materials suitable to enhance adhesion, abrasion resistance, as colorants, as reinforcing or compatibilizing agents or fillers, or as waterproofing materials.

Users of sand and waterproofing construction materials, such as cementitious coatings and other cementitious materials, such as renders or a topcoat of plaster applied to a brick or stone surface, rely increasingly on colored sand to create artificial stone and other aesthetic or appearance affects. However, naturally occurring colored sand must be mined; and it is becoming increasingly rare. Further, the process of mining is water intensive and creates toxic mining tailings that present run off issues and threaten clean water quality. Thus, it would be desirable to enable the provision of a versatile sand like product that can substitute for any natural sand.

In other current uses, known colored particles, such as inorganic fillers, sand and naturally occurring silicates find use in architectural coatings or in molding materials. However, colored sand burnishes easily or is formed in sintering or other harsh, complicated or labor-intensive processes, such as processes involving heating, such as to 100° C. or higher, for example, ceramic colored granules are heated to from 900 to 1200° C., and long drying periods of up to 24 hours or more to treat the particle surface. Any colored sand that has not been modified by such processes is tacky and likely to block or clump on storage or in use. Thus, it remains desirable to provide a durable and free-flowing sand or silicate product in an economical manner.

Still further, finely-divided organic and inorganic particles, including ground waste or scrap particles suffer from an inability to adhere to other surfaces, such as wood, asphalt, rubbery materials or matrix materials that remain critical in today's world, such as plastic or polymer foams. Thus, it would be desirable to enable a way to provide functional, free-flowing particles that can enable the economical provision of aesthetic or functionality enhancing fillers, additives, reinforcing fillers or finely-divided compatibilizing materials.

Recently, U.S. Pat. No. 9,862,832 to Fenelon et al. discloses colored polymeric sand made by mixing a pigment onto the sand to form colored sand, applying an acrylate-based polymeric coating on the colored sand, drying the acrylate-based polymeric coating, and applying a second polymeric material on the dried acrylate-based polymeric coating. The resulting colored sand can be used, for example, between cement and stone pavers to fill the gaps between adjacent pavers and thereby increase the lock between pavers and to stabilize the pavers. However, Fenelon discloses a labor-intensive process that creates sand materials without a controlled particle size and that appears to create a dry layer on the modified sand that is easily burnished or that is a wet tacky product that is not free-flowing or resistant to blocking on storage.

The present inventors have endeavored to create a simple method for making a free-flowing surface modified fine particle having a controlled particle size and, as well, a durable, abrasion resistant surface treatment that confers, for example, a target color, adhesion, compatibility, water resistance or other desirable functionalities to coatings, moldings, foams, films or construction materials.

### SUMMARY OF THE INVENTION

In accordance with the present invention, a method of forming a plurality of free-flowing surface modified particles comprises:
treating a plurality of dry or anhydrous finely divided particles, such as inorganic or organic particles, having a sieve particle size of from 149 to 2000 μm, or, preferably, from 200 to 1680 μm, or, more preferably, from 250 to 1000 μm, with an aqueous or solid activator chosen from a multivalent metal compound or a flocculant, preferably, a multivalent metal compound wherein the metal has a valence of 2+ or 3+, to form activated particles;
mixing the activated particles with a stabilized aqueous composition comprising at least one polymer, such as an anionically stabilized aqueous emulsion polymer composition or an anionic polyurethane dispersion, preferably, a polymer containing one or more acid-functional groups, to form a moist mixture containing 10 wt. % or less of water and, further, containing from 0.3 to 5.5 wt. % or, for example, from 0.6 to 5.5 wt. %, or, preferably, from 1 to 3.5 wt. % of polymer as solids, all wt. % s based on the total weight of the dry or anhydrous finely divided particles and all wt. % s adding up to 100%; and,
drying the moist mixture until it forms a composition that is free-flowing, thereby forming free-flowing finely divided particles having thereon discrete deposits of a solid polymer, wherein at least 80 wt. % of the surface modified particles have a sieve particle size no larger than the sieve particle size of the dry or anhydrous finely divided particles. Preferably, drying the moist mixture comprises active drying and mixing while continuing to agitate the moist mixture until it is free-flowing, such as, for example, fluid bed drying. More preferably, active drying the moist mixture comprises drying and mixing while heating at a temperature of from 30 to 80° C., or, most preferably, from 30 to 60° C. and continuing to agitate the moist mixture until it is free-flowing, for example, fluid bed drying with heat or drying in a jacketing mixer, such as a jacketed concrete mixer, ribbon mixer or paddle mixer. The methods do not encapsulate the finely divided particles; rather they form deposits thereon as solids.

The activator and the stabilized aqueous composition comprising at least one polymer may form an interactive pair that crosslinks or coagulates the polymer, for example, upon mixing them. The interactive pair may be chosen from an anionically stabilized aqueous composition comprising at least one polymer, such as an anionic group containing aqueous polymer dispersion, for example, an aqueous dispersion of a polymer containing an acid-functional group, or such as an anionically stabilized aqueous emulsion polymer, for example, an acid-functional group containing emulsion polymer, and a multivalent metal compound, or a nonionically stabilized aqueous composition comprising at least one polymer, such as a nonionically stabilized aqueous emulsion polymer or aqueous polymer dispersion, and a flocculant.

Preferably, the stabilized aqueous composition comprising at least one polymer further comprises an additional ingredient chosen from a pigment; a filler; an extender; an adhesion promoter; an antioxidant; an antimicrobial; a waterproofing agent; a compatibilizing agent; an antistatic agent; a biostatic agent; a polymer that confers abrasion resistance, such as a polyether ether ketone (PEEK); or a multistage polymer having a hard polymer shell or outer stage; a crosslinking agent, or any two or more thereof. The additional ingredient may be chosen from a coating formulation ingredient, for example, a pigment, an extender, or a colorant, a combination of one or more pigments and one or more extenders, a combination of one or more colorants, one or more pigments and one or more extenders, or a combination of one or more extenders and one or more colorants.

The polymer in the stabilized aqueous composition comprising at least one polymer may inherently confer water resistance to a plurality of surface modified particles or enhance the adhesion of a plurality of such particles to a substrate, such as a rubbery aqueous emulsion polymer or a polyurethane.

The methods may further comprise washing the finely-divided particles before treating them with the activator. Washing may comprise washing with water or with water and up to 2 wt. %, for example, from 0.05 to 1 wt. %, of a nonionic surfactant.

In accordance with the present invention, the free-flowing surface modified particles made by the methods of the present invention meet at least one or, preferably, at least two, or, more preferably, all three, of the following criteria:
(i) the surface modified particle composition comprises 10% or less, or, preferably, 5% or less of polymer solids that are not in the form of deposits on the surface of the particles, based on the total number of particles in the composition, as determined by a visual inspection of a microscopic image of a representative sample of the particles magnified so that the particles have an average diameter of at least 0.4 cm in the image;
(ii) the surface modified particle composition comprises at least 85 wt. %, or, preferably, at least 90 wt. % in the form of simple particles, as determined by a visual inspection of a microscopic image of a representative sample of the particles magnified so that the particles have an average diameter of at least 0.4 cm in the image;
(iii) at least 85 wt. %, or, preferably, at least 88 wt. % of the surface modified particles have the same sieve particle size as the dry or anhydrous finely divided particles; or,
(iv) at least 95 wt. %, or, preferably, at least 97 wt. % of the free-flowing surface modified particles have at least one discrete deposit of solid polymer on their surface, as determined by a visual inspection of a microscopic image of a representative sample showing separate particles magnified so that the particles have an average diameter of at least 0.4 cm in the image of the free-flowing surface modified particles have at least one discrete deposit of solid polymer on their surface.

### BRIEF DESCRIPTION OF THE DRAWINGS

FIG. 1A depicts in a magnified image of colored surface modified glass beads comprising multiple complex particles or agglomerates in accordance with Comparative Example 8.1.

FIG. 1B depicts in a magnified image of colored surface modified glass beads comprising multiple complex particles or agglomerates in accordance with Comparative Example 8.2.

FIG. 1C depicts in a magnified image of colored surface modified glass beads comprising simple particles, each particle having on it one or more discrete deposits of solid polymer in accordance with Example 8.3.

FIG. 1D depicts in a magnified image of colored surface modified glass beads comprising simple particles, each particle having on it one or more discrete deposits of solid polymer in accordance with Example 8.4.

FIG. 1E depicts in a magnified image of colored surface modified glass beads comprising a plurality of simple particles shown in a uniform distribution of the simple particles, each having at least one discrete deposit of solid polymer on its surface in accordance with Example 8.4.

FIG. 2A depicts unmodified sand particles having a sieve particle size of 841 μm (20 mesh) in a magnified image.

FIG. 2B depicts in a magnified image of colored surface modified the same sand as in FIG. 2A comprising simple particles, each particle having on it one or more discrete deposits of polymer in accordance with inventive Example 2.1. The sieve particle size of surface modified sand 1 is the same as the sieve particle size of the unmodified sand in FIG. 2A.

FIG. 3A depicts a magnified image of surface modified particles of inventive Example 13.1, showing that the free-flowing surface modified particles comprise virtually no fragments of unassociated solid polymer modifier or fragments thereof.

FIG. 3B depicts a magnified image of surface modified particles of Comparative Example 13.7, showing that the comparative surface modified particles comprise a substantial number of fragments derived from unassociated solid polymer.

### DETAILED DESCRIPTION

In accordance with the methods of the present invention, a simple method of mixing finely divided particles with an activator and then a stabilized aqueous composition comprising at least one polymer, followed by drying provides a robust particle modifying method. The method finds use with stable aqueous polymer containing compositions, such as emulsion polymers and polymer dispersions, and can be used to modify any particles of the appropriate size. Further, the methods enable a low energy expenditure, mostly in the form of heat if it is used and avoid milling or any grinding of the finely divided particles. Because the methods involve water containing compositions and can upcycle waste particle compositions, they are environmentally friendly. Moreover, the methods themselves enable production of free-flowing surface modified particles with a remarkable degree of accuracy and little or no waste; and the methods can be practiced with a wide variety of mixing and drying equipment. Still further, the methods provide surface modified particles suitable for a broad range of utilities including functional and aesthetic, for example, enhanced compatibility between a dispersed phase and a continuous matrix, such as foam, plastic, blends of polymer or cement. For example, the surface modified particles made by the methods can act as reinforcing fillers or impact modifiers, or they may contain compatibilizing agents or impact modifiers as the additional ingredient.

Unless otherwise indicated, any term containing parentheses refers, alternatively, to the whole term as if no parentheses were present and the term without them (i.e. excluding the content of the parentheses), and combinations of each alternative. Thus, the term “(meth)acrylic” refers to any of acrylic, methacrylic, and mixtures thereof.

Unless otherwise indicated, the term “a” or “an” includes more than one of the referenced thing. Thus, for example, each of the terms “a polymer” or “at least one polymer” includes within its scope one polymer and more than one polymer.

All ranges are inclusive and combinable. For example, a proportion of from 0.7 to 5.5 wt. %, or, preferably, from 1 to 3.5 wt. % of polymer solids, based on the total weight of dry or anhydrous finely divided particles includes any of from 0.7 to 5.5 wt. %, or, preferably, from 1 to 3.5 wt. %, or, from 3.5 to 5.5 wt. %, or, from 0.7 to 1 wt. %, or, from 1 to 5.5 wt. %, or, from 0.7 to 3.5 wt. %, based on the total weight of dry or anhydrous finely divided particles.

As used herein, unless otherwise indicated, the term “standard temperature and pressure” refers to room temperature (21 to 25° C.), atmospheric pressure (1 atm) and indoor ambient relative humidity (RH 40%).

As used herein, the term “addition polymer” means an acrylic or vinyl polymer made by radical polymerization, such as, for example, addition polymerization.

As used herein, the term “anhydrous” means not containing associated water or hydrates. Anhydrous materials usually have been subject to drying treatments and may further have been stored in environments with a relative humidity of 20% or less.

As used herein, the term “anionic group” refers to any molecule having a negative charge at at least one point in a pH of range of from 1 to 14, such as a polymerizable monomer having an acid or acid salt functional group, such as, for example, carboxylic acid, phosphorus containing acid, sulfur containing acid, nitrogen containing acid or salts thereof, including alkali metal salts of acids, such as sodium and potassium carboxylates.

As used herein, the phrase “aqueous” includes water and mixtures comprising 95 wt. % or more, or, preferably, 97 wt. % or more of water in a mixture of water with non-toxic water-miscible solvents, such as ethanol, glycols, propylene glycol alkyl ethers or organic esters, such as ethyl acetate.

As used herein, the term “aqueous emulsion polymer” refers, for example, to a polymer formed from an aqueous emulsion of a polymerizable monomer.

As used herein, the term “aqueous polymer dispersion” refers to any two-phase fluid wherein the continuous phase is aqueous and the disperse phase is a polymer that is dispersible in water by virtue of its own anionic groups, such as carboxyl groups, phosphate groups, or its own cationic groups, such as amines, or by virtue of a dispersing agent, such as a polycarboxylate, or a surfactant.

As used herein, the term “ASTM” refers to the publications of ASTM International, West Conshohocken, PA.

As used herein, the phrase “colorant” means a pigment, a dye or mixtures thereof.

As used herein, the term “complex particles” refers to solid phase particles containing more than one particle domain, such as aggregates, drupels or agglomerates; in contrast, the term “simple particles” refers to particles having one particle domain.

As used herein, the term “dry” means dry to the touch. Unless otherwise indicated, as used herein, the term “dry to the touch” means a free-flowing composition that when blotted with a dry paper towel leaves no moisture or wet residue on the paper towel.

As used herein, the term “free-flowing” refers to a dry material that flows readily, such as by pouring, dispensing or under shear, and that does not agglomerate or stick to itself in neat form when allowed to sit on a shelf or in a container under conditions of standard pressure, at a temperature of from 21 to 25° C., and 40% relative humidity for a period of 7 days or longer or, preferably, 30 days or longer. For example, when 100 grams of the material is poured from one dry container to another under conditions of standard pressure, a temperature of from 21 to 25° C. and 40% relative humidity, each particle of the material will flow independently of all other particles of the same material during pouring and remain separate from all other particles of the same material during and immediately after pouring.

As used herein, the phrase “fluidizable particles” refers to any composition of particles, regardless of moisture content, that can readily be fluidized as individual particles in a fluid bed at room temperature and pressure without further drying or mechanically breaking up the particles.

As used herein, the term “multivalent” includes divalent or higher valent moieties.

As used herein, unless otherwise indicated, the term “average particle size” means a weight average particle size as determined by light scattering (LS) using a Zetasizer Nano ZS particle size analyzer, Malvern, PANalytical Products, Westborough, MA.

As used herein, unless otherwise indicated, the word “polymer” includes, independently, any of homopolymers, copolymers, terpolymers, block copolymers, segmented copolymers, random, block, graft, sequential or gradient polymers, graft copolymers, and any mixture or combination thereof.

As used herein, the term “shelf stable” means that a given ingredient or material will not cure, block or clump, or, if a liquid or fluid, such as a dispersion or emulsion, will not settle when left in an enclosed container for 30 days on a shelf at room temperature, pressure and ambient relative humidity.

As used herein, the term “sieve particle size” refers to the largest particle size of a distribution of finely divided particles that would completely (100 wt. %) pass through a mesh sieve of the given particle size but that would not completely pass through a mesh sieve of the next smaller particle size. For example, a sample of sand particles that passes completely through a 210 μm size sieve (70 mesh) but not through a 177 μm size sieve (80 mesh) is referred to as having a 210 μm sieve particle size. For a given material, a sieve particle size will be larger than the weight average particle size of the same material, as determined by light scattering.

As used herein, the term “simple particle” means a discrete solid phase material having a definite boundary corresponding to a finely divided particle size and comprising one and not more than one separate domain of that solid phase material. While each simple particle may contain one or more discrete deposits of polymer as solids on its surface, it comprises one domain.

As used herein, the term “substantially free of heavy metals” means that a given material has less than 500 ppm, or, preferably, less than 100 ppm, of the heavy metal or compound containing it. As used herein, the term “heavy metals” refers to any metal having an atomic number of 41 or higher with the exception of silver, tungsten and barium, including, for example, cadmium, tin, lead, gold, platinum, palladium, radon, the metals of the actinide series and the metals of the lanthanide series.

As used herein, each of the terms “substantially the same average particle size”, “the same average particle size” or “the same sieve particle size” refers to two materials wherein at least 85 wt. %, or, preferably, at least 90 wt. % of the indicated material has the same sieve particle size as the other material.

As used herein, the term “solid” refers to a material that has a definite capacity for resisting forces which tend to deform it, and under standard conditions retains a definite size and shape. In the methods of the present invention, materials, such as a polymer, may be in fluid form and become solid upon drying.

As used herein, unless otherwise indicated, the term “glass transition temperature”, “Tg” or “measured Tg” refers to the glass transition temperature of a material as determined by Differential Scanning calorimetry using a DISCOVERY 2500 DSC calorimeter (TA Instruments, New Castle, DE (TA)) by drying the indicated material at 20° C. for 16 hours, then cooling it to −90° C. at a rate of 20° C. per minute, then heating it to 80° C. at a rate of 10° C. per minute and then repeating the cooling and heating except heating the material only to 60° C. on the second heating cycle, and scanning in both cooling and heating cycles. The measured Tg of the calorimetry curve is analyzed using TRIOS software (TA) and the reported Tg is the inflection point of the curve of heat flow vs. temperature taken from the scan of the second heating cycle.

As used herein, unless otherwise indicated, the term “calculated glass transition temperature” or “calculated Tg” refers to the glass transition temperature of a material as determined by the Fox Equation as described by Fox in Bulletin of the American Physical Society. 1, 3, page 123 (1956).

As used herein, the term “total solids” or “solids” refers to a fraction of a composition that excludes volatile liquids or fluids, such as water, aqueous liquids or ammonia. Thus, a mixture of 99 weight parts sand particles (at 100% solids), and 2 weight parts of a colored emulsion polymer (at 50% solids) comprises roughly 99 wt. %, based on total solids, of sand particles, and 1 wt. %, based on total solids, of emulsion polymer solids.

As used herein, the phrase “wt. %” stands for weight percent; and the phrase “wt.” stands for weight.

In accordance with the present invention, the methods enable controlled solid phase deposition, forming a plurality of surface modified particles. In the methods, first the finely divided particles are activated by mixing them with the activator. Upon mixing with the stabilized aqueous composition comprising at least one polymer to form a moist mixture, the activator destabilizes the stabilized aqueous composition to trigger the deposition of polymer specifically on the surface of the particle by coagulation or crosslinking. Thus, the activator on the surface of the particles dramatically improves the deposition efficiency of polymer onto a particle surface and makes free-flowing surface modified particles from the moist mixture. The methods thereby minimize the amount of polymer not attached to the surface of a particle. Further, the coagulation or crosslinking of the polymer onto the surface of a particle creates discrete deposits of polymer which are durable and not tacky. This, in turn, minimizes agglomeration during and after processing.

The treating of the present invention comprises simple mixing of the dry or anhydrous particles, with the activator to form activated particles and then mixing them while agitating with a stabilized aqueous composition comprising at least one polymer and drying to give free-flowing surface modified particles that have substantially the same average particle size as the particles prior to the method and that has discrete deposits of polymer as solids on its surface. The free-flowing surface modified particles of the methods of the present invention have a durable surface treatment. Suitable surface treatments may enable any of durable adhesion, color matching, such as would replace or mimic natural stone or sand of various colors, color stability over time, or chemical or light stability, for example, in comprising an antioxidant that enables light or color stability in cement, molding or coating compositions containing it. Other surface treatments may enable waterproofing, which may result from the polymer itself wherein the polymer comprises, as repeating units, at least 25 wt. % of a monomer or repeating unit comprising an aromatic group or a C₁ to C₂₄ alkyl group, such as a fatty ester or ether. Still other surface treatments may confer antimicrobial or biostatic functionality that prevents mold growth or fouling in materials that contain the surface modified particles. However, the surface modified particles made in accordance with the methods of the present invention are not encapsulated; rather, they have one or more polymer deposits on them, and only so much of a surface treatment needed to provide the desired surface modification. The limited degree of surface treatment, in turn helps enable the surface modified particles to remain free-flowing, and to retain the same mechanical properties and substantially the same particle size as the finely divided particles from which it is made.

In contrast to known methods for forming surface modified particles having metal oxide treatments on their surface, for example, via sintering, the methods of the present invention convert particles into high value products while consuming only a small amount of energy, such as heat. In addition, the minimal amount of moisture used in the methods of the present invention enables the production of surface modified particles by simple air drying or no drying at all, i.e. the surface modified particles can be used directly after a short mixing time as the methods rapidly create surface modified particles that are free-flowing or, preferably, both free-flowing and dry to the touch. Moreover, the economical method of the present invention can be practiced in ambient conditions using conventional equipment, such as a cement mixer, and can be carried out on demand in a manufacturing site.

In accordance with the methods of the present invention, the mixing to form the activated particles may comprise simple mixing in a mixer at ambient temperature with little or no heating. Mixing to form the moist mixture may include the mixing and continuing to agitate the moist mixture in a mixer. To avoid agglomeration of the finely divided particles, low shear mixers, e.g. ribbon or plow agitators or mixers, concrete mixers, paddle mixers, Banbury mixers, or Hobart mixers, cone mixers and low-shear kneaders such as extruders may be used. Mixing may comprise tumbling, stirring or agitating. In general, mixing is gentle and does not grind or physically change the shape or size of the finely divided particles. The energy needed to mix the activator and the finely divided particles to form activated particles remains low. Likewise, the energy needed to mix the activated particles and the stabilized aqueous composition comprising at least one polymer remains low. Further, for higher the mixing speeds or the higher the amount of energy transferred from the mixer to the material mixed thereby, the lower the rpm needed. Thus, concrete mixers need lower rpm than Hobart mixers which, in turn, need lower rpm than a handheld mixer. Further, the higher the rpm used in mixing for a given device, the less the time needed to complete mixing. Mixing in the treating or the forming a moist mixture may, independently, comprise mixing at from 10 or more, or, 15 or more, or, 25 or more, or, 40 or more, or, 50 or more, or up to 1000 rpm, or, up to 500, or, up to 300 rpm, or, up to 200 rpm. Further, mixing times in the treating or the forming of a moist mixture may range from 0.5 minute or more, or, 1 minute or more, or, 2 minutes or more, or 5 minutes or more, or, up to 240 minutes, or, up to 120 minutes, or, up to 90 minutes, or up to 60 minutes.

In accordance with the methods of the present invention, the drying may comprise active drying by mixing or agitating, such as in a fluid bed dryer, until the moist mixture is free-flowing; or the drying can comprise passive drying by letting the moist mixture dry while sitting. Drying may comprise processing the moist mixture in a device separate from the device used to mix the moist mixture; however, a gentle mixing device, such as a ribbon mixer or a concrete mixer, can be used for both mixing and drying.

Preferably, drying comprises active drying which is drying while agitating the moist mixture, with or without heat. More preferably, drying comprises heating during active drying, such as in a heated fluid bed dryer or a jacketed, heated concrete mixer. Heating during active drying may comprise heating to from 30 to 80° C. or, preferably, from 30 to 65° C. Excessive heat at 60° C. can disrupt the destabilization effect of the methods, causing the particle and stabilized aqueous composition comprising at least one polymer to precipitate in one phase. However, heat applied during the active drying can increase the efficiency of deposition of polymer onto the particle surface.

Passive drying of the moist mixture may be completed in 4 hours or more, or, 10 hours or more, or, 12 hours or more, or, 15 hours or more, or, in 30 hours or less, or, in 24 hours or less, or, in 20 hours or less, for example, from 10 to 20 hours. In passive drying, heating to a temperature more than 45° C. above, or more than 40° C. above the measured Tg of the polymer having the lowest Tg of any polymer in the stabilized aqueous composition comprising at least one polymer should be avoided.

By active drying while agitating the moist mixture, the moist mixture can be dried more quickly, such as in from 8 to 120 minutes, or, 10 minutes or more, or, 14 minutes or more, or, 75 minutes or less, or 65 minutes or less, or, 60 minutes or less, for example, from 12 to 70 minutes. Active drying devices can include mixing devices kept in a vacuum or devolatilizing oven heated to from 30 to 65° C., or up to 60° C. or devices equipped with a devolatilizer. Active drying may comprise drying in a heated or devolatilizing mixer, such as a heated mixing device, such as a heated ribbon mixer, or a jacketed mixing device, such as a jacketed concrete mixer or paddle mixer, or in a fluid bed dryer. For example, drying may be carried out in a fluid bed dryer or in a vacuum oven, or by drying in the mixer itself under vacuum or heat.

In accordance with the methods of the present invention, there is a limited amount of fluid phase in the moist mixture; and the moist mixture comprises only the amount of water needed to cause the destabilization of the stabilized aqueous composition comprising at least one polymer and its subsequent deposition onto the finely divided activated particles with crosslinking or coagulation of the polymer to lock it onto the activated particles. The methods of the present invention result in surface deposition with little or no waste generation. As a result, the free-flowing surface modified particles comprise 95 wt. % or more, or, preferably, 97 wt. % or more, or even 99 wt. % or more, based on the total solids weight of the surface modified particles as primary particles; and the surface modified particles comprise almost none, or 3 wt. % or less, or 5 wt. % or 10 wt. % or less, based on total solids of unmodified finely divided particles, of undeposited polymer particles that are not present as deposits on the surface modified particles. Accordingly, the methods may consist essentially of the disclosed treating, mixing and drying methods while avoiding a separation or filtering step.

In the methods, the amount of water in the moist mixture does not exceed 10 wt. %, based on the total weight of the moist mixture. Excessive amounts of water disrupt formation of free-flowing surface modified particles, giving too wet a product. Where drying comprises passive drying, the amount of water in the moist mixture should not exceed 8 wt. %, based on the total weight of the moist mixture.

In the methods, a higher concentration of surface treatment may result from a multistage method wherein surface modified particles are treated. Such methods may comprise:
treating a plurality of free-flowing surface modified particles in accordance with the present invention with an aqueous or solid activator chosen from a multivalent metal compound or a flocculant to form activated particles;
mixing the activated particles with a stabilized aqueous composition comprising at least one polymer to form a moist mixture having 10 wt. % or less of water and, further, having from 0.2 to 5.5 wt. %, or, from 0.3 to 5.5 wt. % or from 0.6 to 5.5 wt. % or from 0.6 to 3.5 wt. % of polymer solids, all wt. % s based on the total weight of the surface modified particles and all wt. % s adding up to 100%; and,
drying the moist mixture until it forms a composition that is free-flowing. The methods can be repeated successively on surface modified particles that have been treated twice or even three times.

Suitable activators may include, for example, coagulation agents and multivalent metal compounds such as those containing multivalent metals dispersible in water. To match the stabilized aqueous composition comprising at least one polymer, the activator may be chosen to create an interactive pair chosen from an anionically stabilized aqueous composition comprising at least one polymer, for example, an anionically stabilized aqueous emulsion polymer or an aqueous dispersion having one or more anionic groups, and a multivalent metal compound, or a nonionically stabilized aqueous composition comprising at least one polymer and a flocculant.

Multivalent metal activators may be any known multivalent metal compound that can be dissociated in water, such as, for example, any chosen from a salt, or a Lewis Acid, such as iron (ferric) chloride, i.e. FeCl₃, iron (ferrous) sulfate, i.e. Fe₂(SO₄)₃, alum, i.e. Al₂(SO₄)₃, calcium sulfate; or a water dispersible oxide, such as calcium hydroxide, preferably FeCl₃. Sulfates and phosphates are preferred because they dissociate quickly in water to free the metal cations. The activators may include water in amounts whereby the total amount of water in the moist mixture does not exceed 10 wt. %, based on the total weight of the moist mixture. Preferably, the multivalent metal compound comprises a trivalent metal chosen from aluminium or iron, or, more preferably, sulfates or phosphates thereof.

In accordance with the methods of the present invention, multivalent metal compounds should be used in amounts such that they aid the deposition of the stabilized aqueous composition comprising at least one polymer on the surface of free-flowing activated particles and crosslink the anionic groups in the polymeric binder. Suitable amounts of multivalent metal compounds, as solids, range from 0.1 to 3.0 wt. %, or, preferably, 0.15 wt. % or more, or, preferably, 1.5 wt. % or less or, more preferably, 1.0 wt. % or less, based on the total weight of the dry or anhydrous finely divided particles.

In accordance with the methods of the present invention, suitable flocculating agents for use with nonionically stabilized composition comprising a polymer may comprise nonionic flocculants, such as polyacrylamides, polyethyleneimines, or bentonite or kaolin clays in particulate form for use with nonionically stabilized aqueous polymers.

A suitable non-ionic flocculant may comprise any high molecular weight polyacrylamides used in waste water treatment, or a finely divided clay in a dry or anhydrous form. A suitable polymeric flocculant may comprise any polyacrylamide, poly(alkyl (meth)acrylate), or vinyl polymer having a neutral or a negative overall charge, such as can be obtained by introducing anionic comonomer units, such as, anionic comonomers having a carboxylic acid, phosphorus containing acid, sulfur containing acid, nitrogen containing acid or acid salt functional group, with one or more acrylamides, acrylates, or vinyl monomers not having a cationic or anionic group. Flocculants may be used as concentrated solutions in water. Preferably, to insure mixing without excessively rapid thickening or precipitation, the polymeric flocculant finds use in moist mixtures having a pH of 10 or below, or, preferably. 9 or below.

Suitable flocculant polymers may have a weight average molecular weight in the range from 100,000 to 30,000,000 g/mole, such as, for example, at least 1,000,000 g/mole, or, preferably, from 5,000,000 to 30,000,000 g/mole.

In the methods, the amount of the multivalent metal activator solids can range from 0.2 to 2 wt. %, based on the total weight of the moist mixture. However, to insure effective treatment of the finely divided particles, the ratio of water to multivalent metal activator solids may range from 4:1 to 36:1.

In the methods, the amount of the flocculant may range from 1 to 10 wt. %, or, preferably. 6 wt. %, based on the total weight of the moist mixture. However, to insure effective treatment of the finely divided particles, the ratio of water to flocculant activator solids may range from 0.8:1 to 9:1.

Finely divided particles may be inorganic or organic. Suitable inorganic finely divided particles may be chosen from quartz sand, glass sand, river sand, lake sand, beach sand, sea sand, desert sand, machine-ground sand, calcium carbonate, or naturally occurring inorganic silicate particles, such as wollastonite, feldspar, ground sandstone, ground shale or talc. The inorganic finely divided particles are dense and may have a density ranging from 2.0 to 5.5 g/cm³. Suitable organic finely divided particles may be chosen from organic nut shell resins, such as ground walnut shell or walnut shell resins, crosslinked rubber, ground rubber, such as ground tire rubber that is substantially free of heavy metals, or a recycled, ground phenolic resin circuit board material that is substantially free of heavy metals, recycled ground nylon, recycled ground poly(ethylene terephthalate) (PET) or recycled ground polycarbonate or mixtures thereof. Suitable sand may include, for example, quartz sand, glass sand, river sand, sea sand, or desert sand.

To minimize surface contaminants the methods may further comprise washing the finely-divided particles, such as sand, before treating them with the activator. Prewashing the finely-divided particles and thereby wetting them also facilitates treating them with the activator.

The stabilized aqueous composition comprising at least one polymer may comprise an aqueous emulsion polymer, or an aqueous polymer dispersion, such as a polyurethane dispersion (PUD). Further, the stabilized aqueous composition may comprise one or more additional ingredients that enhance or enable the performance of the surface modified particles. The additional ingredient may impart a desired color, or enhance any of a coating property, such as coating formation, reflectivity, UV blocking, adhesion, antimicrobial activity, mold resistance, antistatic activity, abrasion resistance, water resistance or compatibilization with a matrix. The additional ingredient may be, for example, a coating formulation ingredient, such as, for example, one or more pigments, fillers, or extenders, such as those having a refractive index above 2.7, or colorants, including dyes. Other suitable additional ingredients may include adhesion promoters, antioxidants, antimicrobials, such as moldicides, abrasion resistant polymer particles, waterproofing agents, compatibilizing agents, anti abrasion additives, such as a crosslinking agent having two or more polymerizable groups that react with the polymer in the stabilized aqueous composition; antistatic agents or biostatic agents. Further, the polymer in the stabilized aqueous composition may itself confer enhanced adhesion, abrasion resistance or water resistance, such as in the case of a polyurethane dispersion or a polymer having a measured Tg of 10° C. or less, for example, a rubbery polymer. Harder polymers having a measured Tg above 25° C., or multistage polymers having harder polymers as the shell or outer stage may confer abrasion resistance.

In accordance with the methods of the present invention, the stabilized aqueous composition comprising at least one polymer may comprise aqueous polymers prepared by any known method, including bulk or solution polymerization, followed by aqueous dispersion by conventional techniques and, if needed, removal of organic solvent; or by aqueous dispersion, suspension, or emulsion polymerization; or by any other known method that would produce a stable polymer dispersion in water.

Suitable polymers for use in the stabilized aqueous composition may be made by aqueous emulsion polymerization of acrylic or vinyl monomers, or dispersion thereof in the presence of anionic or nonionic surfactants or acid group containing dispersing agents. The emulsion polymerization to form an aqueous emulsion polymer can be carried out by conventional techniques known to those of ordinary skill in the art, such as those described in Blackley, D. C. Emulsion Polymerisation: Applied Science Publishers: London, 1975; Odian, G. Principles of Polymerization; John Wiley & Sons: New York, 1991; or in Emulsion Polymerization of Acrylic Monomers; Rohm and Haas, 1967.

Stabilized polymers may contain anionic groups, like carboxylic acid, or carboxylate groups, or nonionic surfactant functional groups, such as oxyalkylene groups, or, they may be stabilized by adding anionic, nonionic, or amphoteric surfactants or acidic dispersing agents. Surfactant amounts contained in the stabilized aqueous composition comprising at least one polymer may comprise 2 wt. % or less, based on the weight of the stabilized aqueous composition comprising at least one polymer, of one or more surfactants, preferably, from 0.05 to 1 wt. %.

A suitable aqueous emulsion polymer may contain, as polymerized units, one or more nonionic ethylenically unsaturated monomers. Examples of these ethylenically unsaturated monomers include: C₁-C₂₄ linear or branched chain alkyl (meth)acrylates, such as methyl (meth)acrylate, bornyl (meth)acrylate, isobornyl (meth)acrylate; (meth)acrylamide or substituted (meth)acrylamides; styrene or substituted styrenes; butadiene; vinyl acetate or other vinyl esters; and (meth)acrylonitrile. As used herein, the word fragment “(meth)acryl” refers to both “methacryl” and “acryl”: for example, the term “methyl (meth)acrylate” refers to both methyl methacrylate and methyl acrylate.

An example of a suitable aqueous emulsion polymer for use in the methods of the present invention may comprise the copolymerization product of a first acrylic or vinyl monomer having a measured glass transition temperature (Tg) as measured by DSC of from −40 to 70° C., or, preferably, −25° C. or higher, or, preferably, −20° C. or higher. Monomers for making the acrylic or vinyl polymers may be any known monomer, and generally comprise two or more copolymerizable monomers, such as butyl acrylate (BA), vinyl acetate or ethylhexyl acrylate (EHA), methyl methacrylate (MMA) or styrene. Preferred acrylic or vinyl polymers may be chosen from any polymer comprising the reaction product of 25 wt. % or more of an acrylic monomer.

Acid-functional groups may include carboxylic and carboxylate groups or phosphorus-acid groups. Suitable acid-functional group containing monomers useful in forming anionically stabilized emulsion polymer of the present invention include, for example, (meth)acrylic acid, itaconic acid, crotonic acid, phosphorus acid monomers, like phosphoethyl (meth)acrylate, sulfoethyl (meth)acrylate, 2-acrylamido-2-methyl-1-propanesulfonic acid, fumaric acid, maleic anhydride, monomethyl maleate, maleic acid, or salts thereof. As used herein, the term “(meth)acrylic acid” refers independently to methacrylic acid, acrylic acid, or mixtures thereof. Suitable phosphorus acid group-containing monomers suitable for use in forming an anionically stabilized emulsion polymer may include phosphonates and dihydrogen phosphate esters of an alcohol in which the alcohol contains or is substituted with a polymerizable vinyl or olefinic group.

Other suitable polymers for use in the stabilized aqueous composition comprising at least one polymer may comprise urethanes, polyesters, polyamides, or, preferably, any acrylic or vinyl polymer, such as acrylic-styrene polymers or styrene polymers, or any urethane, vinylacetate-ethylene or other polymers from vinyl esters, such as vinyl acetate or vinyl versatate. Preferably, a suitable aqueous dispersion polymer is an anionic polyurethane dispersion which is acid stabilized, such as by dimethylol propionic acid, or an emulsion polymer stabilizer with a fatty alkyl or aryl sulf(on)ate, such as a fatty alkyl (poly)ether sulfate like sodium laureth sulfate.

The stabilized aqueous composition comprising at least one polymer of the present invention generally has a conventional solids content ranging from 30 to 80 wt. %, or, preferably, from 40 to 70 wt. %, based on the total weight of the stabilized aqueous composition. The stabilized aqueous composition comprising may further include any one or more additional ingredients as solids, such as pigments, fillers and extenders. Higher solids contents provide polymeric binders that dry in less time.

Suitable stabilized aqueous emulsion polymers or polymer dispersions may contain up to 2.5 wt. % or, preferably, up to 2 wt. %, or, more preferably, up to 1 wt. %, in total, of emulsifiers, dispersing agents, and surfactants, based on the total weight of the stabilized aqueous composition comprising at least one polymer.

The stabilized aqueous composition comprising at least one polymer may further comprise one or more thickeners, colloidal stabilizers and rheology modifiers, such as cellulosic ethers, hydrophobically modified ethoxylated urethanes (HEUR) or hydrophobically modified alkali swellable emulsion polymers (HASE). The combined materials in the previous sentence all comprise stabilizing materials or groups that enable a stabilized aqueous composition; and these stabilizing materials or groups specifically exclude the activator of the present invention.

Anionically stabilized aqueous compositions comprising a polymer form interactive pairs with multivalent metal activators. Preferably, the stabilized aqueous composition comprising at least one polymer comprises an anionically stabilized aqueous emulsion polymer or an anionic aqueous dispersion polymer. More preferably, the anionically stabilized aqueous composition comprises at least one acid-functional group in the polymer, such as an anionic polyurethane dispersion or an emulsion polymer comprising, in polymerized form, anionic functional group containing monomers, such as acid-functional group containing monomers. Suitable amounts of anionic functional group containing monomers may range from 0.01 to 5 wt., or, from 0.1 to 5.0 wt. %, or, preferably. 3 wt. % or less, for example, from 0.02 to 3 wt. %, based on the total weight of the monomers used to form the emulsion polymer.

Suitable amounts of polymer solids from the stabilized aqueous composition comprising at least one polymer may range from 0.7 to 5.5 wt. %, or, preferably, from 1 to 3.5 wt. %, based on the total weight of the moist mixture.

In accordance with the methods of the present invention, the additional ingredient may be chosen from pigments, fillers, extenders, colorants, adhesion promoters, antioxidants, antimicrobials, such as moldicides, waterproofing agents, compatibilizing agents, antistatic agents or biostatic agents, or any two or more thereof. Suitable pigments may be chosen from iron oxides, titanium dioxide, and other metal oxides, such as aluminum oxides, and mixtures of two or more thereof. Suitable extenders or fillers may include, for example, calcium carbonate, silicon dioxide, barium sulfate, mica. Suitable colorants may be chosen from, for example, ketopyrrolopyrroles, perylenes and phthalocyanines and mixtures of two or more thereof, or, preferably, one or more colorants mixed with one or more pigments. For use as an adhesion promoter, the additional ingredient may comprise oxysilanes, especially oligoxoysilianes or oligoxysilanes containing organic groups, such as alkyl, aryl, or condensation reactive groups like phenols or oxiranes. Suitable antioxidants may include, for example, butylated hydroxyanisole (BHA), butylated hydroxytoluene (BHT), propyl gallate, tocopherols, and polyphenols, such as anthocyanines and flavonoids. Suitable antimicrobials may include, for example, isothiazolinones, such as methyl isothiazolinone, pyrethrins and pyrethroids, quaternary ammonium compounds, sodium benzoate.

Preferably, the stabilized aqueous composition comprising at least one polymer contains a total amount of organic solvents, such as co-solvents or coalescents, for example, ester alcohols or glycol ethers, or alkyl ethers; and, of not more than 5 wt. %, or, not more than 4 wt. %, based on the total weight of the stabilized aqueous composition comprising at least one polymer.

More preferably, the stabilized aqueous composition comprising at least one polymer is an aqueous emulsion polymer that contains a total amount of organic solvents, co-solvents, and coalescents of no more than 5 wt. %, or, preferably, no more than 3 wt. %.

The free-flowing surface modified particles of the present invention comprise a plurality of finely divided surface modified particles having the same particle size as the starting finely divided particles. Thus, the surface modified particles may have a sieve particle size of from 149 to 2000 μm, or, from 200 to 1680 μm, or, more preferably, from 250 to 1000 μm.

The discrete deposits of polymer on the surface of the surface modified particles may have a weight average diameter at its largest dimension which is only a fraction of the size of the surface modified particles, for example, from 1/50^{th} to ½ of the sieve particle size of the surface modified particles the weight average diameter as determined by light scattering. The average diameter of the discrete deposits of polymer, as determined by light scattering, may range from 3 to 200 μm or, for example, from 5 to 150 μm. Each of the discrete deposits of polymer may contain one or more additional ingredients. The additional ingredients may be chosen from any pigments, fillers, extenders, colorants, adhesion promoters, antioxidants, antimicrobials, such as moldicides, waterproofing agents, compatibilizing agents, antistatic agents, biostatic agents, or any two or more thereof.

The present invention discloses and relates to the following clauses:

CLAUSE 1. A method comprising:
treating a plurality of dry or anhydrous finely divided particles with an aqueous or solid activator chosen from a multivalent metal compound or a flocculant;
mixing the activated particles with a stabilized aqueous composition comprising at least one polymer containing one or more additional ingredient chosen from a pigment, filler, extender, colorant, adhesion promoter, antioxidant, antimicrobial, such as moldicides, waterproofing agent, compatibilizing agent, antistatic agent, biostatic agent, a polymer that confers water resistance, a polymer that confers abrasion resistance, a crosslinking agent, or any two or more thereof to form a moist mixture having 10 wt. % or less of water; and,
drying the moist mixture while continuing to agitate the moist mixture until free-flowing, thereby forming a composition comprising free-flowing surface modified particles having discrete deposits of binder on its surface,
wherein at least 85 wt. % of the surface modified particles have the same sieve particle size as the dry or anhydrous finely divided particles.

CLAUSE 2: The method of clause 1, wherein at least 88 wt. %, or, preferably, at least 90 wt. % of the surface modified particles have the same sieve particle size as the dry or anhydrous finely divided particles.

CLAUSE 3: The method of any one of clauses 1 or 2, wherein the finely divided dry or anhydrous particles have a sieve particle size of from 149 to 2000 μm, or, preferably, from 200 to 1680 μm, or, more preferably, from 250 to 1000 μm.

CLAUSE 4: The method of any one of clauses 1, 2, or 3, wherein the finely divided dry or anhydrous particles are chosen from inorganic particles which have a density ranging from 2.0 to 5.5 g/cm³ and organic particles, such as ground walnut shells, ground circuit board, ground rubber particles.

CLAUSE 5: The method of any of the clauses 1, 2, 3 or 4, wherein the activator comprises a metal containing coagulant, a Lewis acid, or another di-valent or multi-valent metal compound.

CLAUSE 6: The method of any of the clauses 1, 2, 3, 4 or 5, wherein the additional ingredient is chosen from a pigment, an extender, a filler, a colorant, an antioxidant, an antimicrobial, a polymer that confers water resistance, a polymer that confers abrasion resistance, such as a polyether ether ketone (PEEK), a crosslinking agent, or any two or more thereof.

CLAUSE 7. The method of any one of the previous clauses 1 to 6, wherein the drying comprises any of:
active drying by mixing until the moist mixture is free-flowing in a heated or devolatilizing mixer;
active drying a fluid bed dryer or vacuum or devolatilizing oven heated to from 30 to 65° C. for a period of from 15 to 75 minutes.

CLAUSE 8. The method of any one of items 1 to 7 consisting essentially of
treating the finely divided dry or anhydrous particles with the activator to form activated particles;

mixing the activated particles with a stabilized aqueous composition comprising at least one polymer containing an additional ingredient chosen from an antioxidant compound, an antimicrobial compound, a colorant, a waterproofing agent, or any two or more thereof to form a moist mixture; and,
drying the moist mixture while continuing to agitate the moist mixture until free-flowing to form surface modified particles having discrete deposits of polymer as solids on their surface, while avoiding a grinding or milling step.

CLAUSE 9. The method of any of the clauses 1 to 8, wherein the moist mixture comprises no more than 10 wt. % or, preferably, no more than 5 wt. % in total based on the total weight of the moist mixture, of the combined amount of organic solvents, co-solvents, and coalescing solvents.

CLAUSE 10. The method of any one of clauses 1 to 9, wherein the stabilized aqueous composition comprising at least one polymer is chosen from a polyurethane dispersion or an aqueous emulsion polymer having a measured Tg (DSC) of 10° C. or less that confers enhanced adhesion or water resistance.

CLAUSE 11. The method of any of items 1 to 10, wherein the dry or anhydrous finely divided particles are chosen from sand, a silicate, a nut shell resin powder, crosslinked rubber, recycled rubber that is substantially free of heavy metals, ground recycled circuit board material that is substantially free of heavy metals, recycled ground nylon, recycled ground poly(ethylene terephthalate) (PET), recycled ground polycarbonate or mixtures thereof.

CLAUSE 12. The method of any one of clauses 1 to 11, wherein the surface modified particles exhibit a Water Contact Angle (WCA) of at least 80°, as determined by capturing an image of a vertical cross-section of a 20 μL droplet of a colorant containing aqueous dispersion on the level top surface of a 2 mm thick level packed layer of the surface modified particles and measuring the contact angle using a Java-based image processing program, for example, ImageJ software (US NIH, Bethesda, MD).

CLAUSE 13. The method of any one of clauses 1 to 11, wherein the surface modified particles exhibit enhanced ultraviolet resistance, expressed as an ultraviolet light (UV) transmittance of 2% or less or, preferably, 1% or less, as determined by measuring the % transmittance of UV energy passing through a 1 mm thick packed layer of the surface modified particles completely covering the sensor hole of a UV chamber, such as a QUV-SE QUV Chamber (QUV-SE, Q-Lab Corp., Westlake, OH (Q-Lab)) equipped with eight UVA340+ UV Light Bulbs (Q-Lab), and testing at 45° C. and a UV energy level of 0.89 W/m² at 340 nm using a UV513AB UVA/B Light Meter (General Tools and instruments, Secaucus, NJ).

CLAUSE 14. The method of any one of clauses 1 to 11, wherein a 1 mm thick packed 5 cm by 5 cm layer of the surface modified particles exhibit at least 10% greater, or, at least 15% greater, or, at least 20% greater, or, at least 30% greater 90 degree adhesion to a substrate, such as a 1 cm thick concrete layer or a polymer film, for example, high density polyethylene, as measured in accordance with ASTM D6862 in comparison to adhesion of a 1 mm thick packed 5 cm by 5 cm layer the same finely divided particles which are not surface modified to the same substrate.

### EXAMPLES

The following examples illustrate the present invention. Unless otherwise indicated, all temperatures are ambient temperatures (21-23° C.), all pressures are 1 atmosphere and relative humidity is 30%.

In the examples that follow, the following abbreviations were used: DI water: Deionized water; GTR: Ground tire rubber; Tg Glass transition temperature; R.T.: Room temperature; SA: styrene acrylic: SB: styrene butadiene; PUD: polyurethane dispersion; VAE: vinyl acetate ethylene; Monomers: BA: butyl acrylate; MAA: methacrylic acid; MMA: methyl methacrylate; EHA: 2-ethylhexyl acrylate; LMA: lauryl methacrylate; IAA: isoascorbic acid; STY: styrene; WCA: water contact angle; DSC: differential scanning calorimetry; MFFT: minimum film forming temperature; PVC: particle volume concentration.

In the Examples that follow, the materials used in making stabilized aqueous polymer formulations and in various tests are shown in Tables 1, 2, and 3, below. As used below, the term “water” refers to deionized water. The stabilized aqueous compositions comprising a polymer that were used in making various surface modified particles tested in the examples are listed in Tables 4A and 4B, below.

The equipment used in the Examples that follow is listed in Table 5, below.

TEST METHODS: The following test methods were used in evaluating the present invention.

Dry to the Touch: A composition is placed in a container in which its depth measures at least 3 cm deep and its surface leveled. A tongue depressor is inserted into a given composition at an angle normal to the surface of the composition and to a depth of at least 3 cm, held for at least 2 seconds and then retracted. If there is no residue or adherent material on the tongue depressor after retraction, the composition can be said to be dry to the touch.

Glass transition temperature (Tg): Tg was measured using a DISCOVERY 2500 DSC calorimeter (TA Instruments, New Castle, DE (TA)) by drying the indicated material at 20° C. for 16 hours, then cooling it to −90° C. at a rate of 20° C. per minute, and then heating it to 80° C. at a rate of 10° C. per minute. Cooling and heating was repeated once, scanning in both cooling and heating cycles with heating the material only to 60° C. on the second heating cycle. The glass transition temperature (Tg) of the calorimetry curve was analyzed using TRIOS software (TA) and the Tg measured was the inflection point of the curve of heat flow vs. temperature. The reported Tg was that taken from the scan of the second heating cycle.

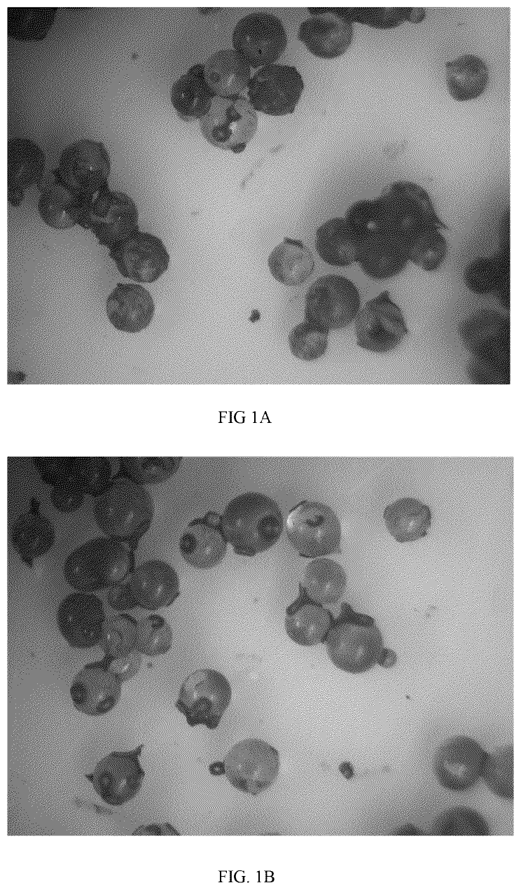

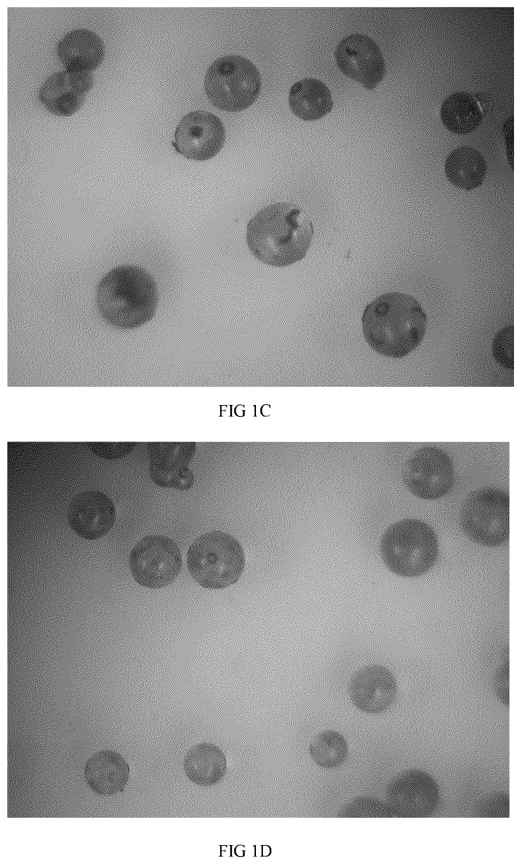

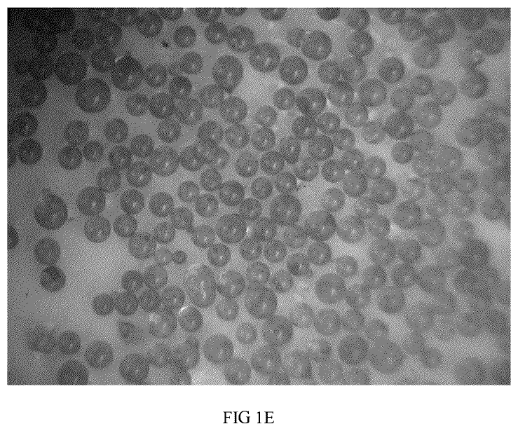

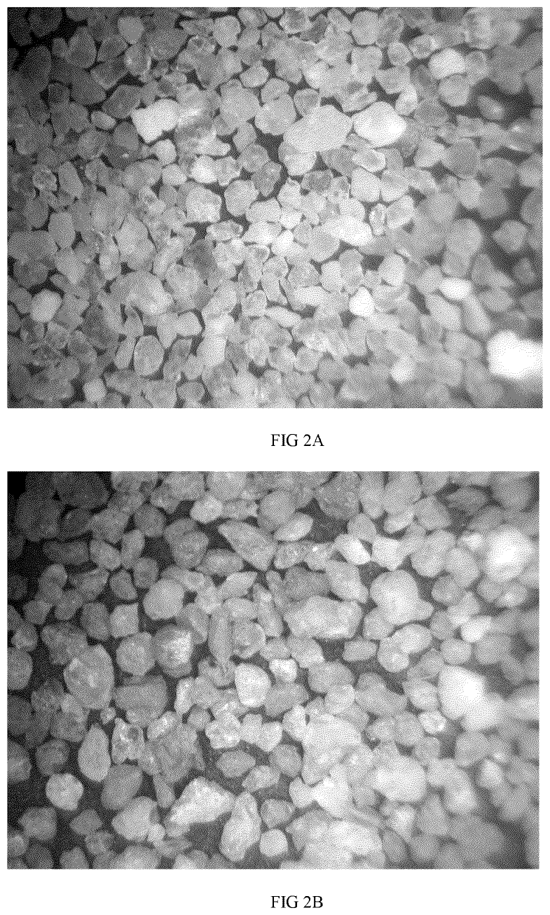

Microscopic Imaging: Imaging was carried out by placing the indicated compositions on a microscope stage and imaging using an AMSCOPE Microscope (United Scope LLC, Irvine, CA) equipped with an OMAX A35180U3 Microscope Camera (United Scope) and an OMAX TOUPVIEW Software (United Scope). Imaging was used at various magnification levels. Microscopic images appear in FIGS. 1A, 1B, 1C, 1D, 1E, 2A, 2B, 3A and 3B.

Counting Particles in microscopic images was performed by hand. Surface modified particles were placed on a black vinyl Leneta chart. A magnifying glass with LED lights and scales and an Iphone were used to capture the magnified images of the particles and a 1 cm×1 cm surface area was selectively cropped off from the magnified image for counting. Particles were counted and numbered by hand, and were classified as having a sieve particle size of from 400 to 841 μm (40 to 20 mesh) and as having a much smaller size, such as 50 μm.

Minimum Film Forming Temperature (MFFT): MFFT was measured using a BGD 452 Minimum Film-Forming Temp. tester (Biuged Precise Instruments Co., Ltd., Guangzhuo, PRC) with a temperature range set from −5° C. to 30° C. Scotch tape was placed on the surface of the MFFT plate to prevent contamination on the MFFT plate and hold the indicated material in place. The material was drawn down on the scotch tape using an applicator with a μm 100 gap and the product was left for at least 2 hours to form a film. The recorded MFFT was the point at which cracks formed in the film.

Particle-Asphalt Membrane Adhesion: To test adhesion, a 5 kg cylindrical metal weight was preheated in an 80° C. oven overnight to equilibrate temperature. A piece of aluminum foil was then placed on the top of a 3.5 kg cylindrical metal weight, and the entire assembly was preheated in an 80° C. oven overnight to equilibrate temperature. An asphalt waterproof membrane (SAM-930, Oriental Yuhong Ltd. Beijing Oriental Yuhong Waterproof Technology Co., Ltd., Beijing, China) was cut into 2 cm×2.5 cm pieces, then the protective liner was removed, and the weight of each piece was measured. Each piece of asphalt membrane and the indicated particle composition was preheated in an 80° C. 5 min. Each preheated particle composition was poured onto the aluminum foil and levelled to evenly cover the foil surface. A piece of the asphalt membrane was then placed onto the surface of each particle composition and then an excess of the particle composition needed to cover the piece of asphalt membrane was poured on top of the asphalt membrane and then levelled to form a continuous layer of the particle composition on the membrane. Then the preheated 5 kg metal weight was placed on top of the particle surface and allowed to sit for 1 min. The 5 kg metal weight was then removed, any loosely attached particles brushed off from the asphalt membrane, and then the weight of the asphalt membrane with particles was measured. The weight gain for the asphalt membrane was then calculated and reported as the result, with a larger weight gain being better. Particle adhesion results are reported in Table 16, below.

pH: The pH of each indicated composition was measured using a calibrated HI 5522 pH Meter (Hanna Instruments, Woonsocket, RI) equipped with a PH-9009 pH Electrode (Paul N Gardner Co, Pompano Beach, FL). Approximately 15 g of each indicated composition was placed in a 20 mL vial to insure that the electrode was submerged in the composition. Measurements were taken at the first reading at which the pH meter read “stable”.

Y-Reflectance: A packed layer of a given composition was formed in a 100 mm long×100 mm wide×2 mm thick mold equipped with a white BYK chart (Byk Gardner USA, Columbia, MD) on the bottom inside face and having an open top to form and with a leveled top surface. The reflectance of the leveled top surface of the packed layer was measuring using a NOVOSHADE Duo+ Reflectance Sensor (Rhopoint Instruments Ltd, East Sussex, UK). The reported reflectance was an average of 4 measurements of each composition tested. The higher the reflectance, the better. Reflectance results are reported in Tables 8, 11 and 14, below.

Sieve Test: Each indicated composition was tested for agglomeration by placing it in an AS-200 Sieving Machine (Retsch GmbH, Dusseldorf, DE) equipped with the sieve of the size of the indicated finely divided particle in Table 3, below. The sieve size generally has a mesh size that is larger than and most closely matching the upper limit of the unmodified particle, and then sieving it using an AS-200 Sieving Machine (Retsch) set at 60% vibration amplitude for 20 min. A composition achieving at least an 80 wt. % passage through the sieve was considered a pass. In a tumbling and sieve test, the indicated composition was placed in a 19 L (5 Gal) concrete mixer (Humboldt) equipped with a 5-gallon bucket and tumbling at 56 rpm for 10 min prior to sieving.

UV Blocking: Each indicated composition was placed and packed into a mold unit formed by 2 BS-72P Glass Slides (United Scope) as the top and the bottom of a 55 mm long×1.5 mm wide×1 mm thick cavity, having a 1 mm gap between the glass slides, having material packed between the slides. The mold unit was placed into a QUV Sample Holder (Q-Lab Corp., Westlake. OH) slot on the outside of a UV513AB UVA/B Light Meter (General Tools and instruments, Secaucus, NJ) having a sensor hole so that the packed layer completely covered the sensor hole. The light meter having the packed glass slide covering the sensor hole was then placed in a QUV-SE QUV Chamber (Q-Lab) equipped with 8 UVA340+ UV Light Bulbs (Q-Lab), and UV blocking was tested at 45° C. and a UV energy level of 0.89 W/m² at 340 nm. UV blocking results are reported in Table 17, below.

Water Contact Angle (WCA); The indicated composition was placed and packed into a mold (60 mm long×10 mm wide×2 mm thick) equipped with a closed and level bottom and an open top placed on a level stage to form a packed layer having a level top surface, then placing a 20 μL droplet of an aqueous dispersion prepared by mixing 200 g deionized water and 0.01 g Colorant (Keytec Colors) on the level top surface, and capturing an image of a vertical cross-section of the aqueous dispersion droplet on the top surface of the packed layer of using a MATE9 Cellphone (Huawei Technologies Co., Ltd., Shenzhen, PRC). The contact angle of the droplet was then measured using ImageJ software (US NIH, Bethesda, MD). The water contact angle reported was the average of 3 measurements. The higher the WCA, the better. Water contact angle results are reported in Table 15, below.

Coatings Standards Calculations: Where the exact formulation of commercial paints is not known, the particle volume concentration (PVC) was used to estimate polymer solids and overall solids based on the knowledge of the gloss or sheen of the paint. For any paint, the % PVC is defined by the following equation (I),

$$\begin{matrix}\% PVC = \frac{{V}_{P}}{{V}_{B} + {V}_{P}} & \times 100 \%\end{matrix} \qquad ( I )$$

wherein, V_{P} is the total volume of the pigment, filler and extenders, and V_{B} is the volume of the polymer. Without the %, PVC can also just be expressed as a ratio less than 1. For any paint, the total solids content defined by the following equation (II),

$${M}_{T S} = {M}_{B} + {M}_{P} \qquad ( II )$$

wherein, M_{TS}, M_{B}, and M_{P} are, respectively, the mass of total solid, mass of polymer, and the mass of pigment. For any paint, M_{B} and M_{P} are defined by the following equations (III) and (IV),

$${M}_{B} = {V}_{B} * {ρ}_{B} \qquad ( III )$$

$${M}_{P} = {V}_{P} * {ρ}_{P} \qquad ( IV )$$

wherein, ρ_{B} and ρ_{P} are, respectively, the density of polymer and pigment. From (I), pigment, extender and filler volume can be expressed as (V):

$${V}_{P} = {V}_{B} \frac{PVC}{1 - P V C} , \qquad ( V )$$

From (II), total solids can be expressed as (VI):

$${M}_{T S} = {V}_{B} {ρ}_{B} + {V}_{P} {ρ}_{P} ; \qquad ( VI )$$

And, as a result, (VI) becomes (VII) and (VIII)

$${M}_{T S} = {V}_{B} {ρ}_{8} + {V}_{B} {ρ}_{B} \frac{P V C}{1 - P V C} \frac{{ρ}_{P}}{{ρ}_{B}} \qquad ( VII )$$

$${M}_{T S} = {M}_{B} ( 1 + \frac{PVC}{1 - PVC} \frac{{ρ}_{P}}{{ρ}_{B}} ) . \qquad ( VIII )$$

Thus, for example, from the above equations, for a satin paint such as APD10, where the gloss is satin, the estimated % PVC ranges is 30 to 40%. In the above equations, for acrylic polymers, ρ_{B} is estimated to be 1.185 g/ml. For pigments in general, pp is estimated to be 2.65 g/ml for silica, 2.71 g/ml for CaCO₃, and 4.23 g/ml for TiO₂, respectively. So, in general for satin coatings, when total solids (M_{TS}) is 60.8 wt. %, as in APD9, polymer solids (M_{B}) ranges from 18.0 to 31.0 wt. %; when total solids (M_{TS}) is 60.2 wt. %, as in APD10, polymer solids (M_{B}) ranges from 17.8 to 30.7 wt. %; when total solids (M_{TS}) is 43.5 wt. %, polymer solids (M_{B}) ranges from 12.9 to 22.2 wt. %. For flat coatings, when total solids (M_{TS}) is 42.0 wt. %, as in APD11, polymer solids (M_{B}) ranges from 10% to 14.7 wt. %.

Synthesis of AEP 1, 2 and 4: Synthesis of the indicated stabilized aqueous compositions comprising a polymer was performed, as follows:

AEP 4: To form the emulsion polymer (stabilized aqueous composition) in AEP 4, to a 2-liter glass round bottom, four neck flask equipped with overhead mechanical stirring, external resistive heating, an electronic temperature controller coupled to a pneumatic pot lifter, external water cooled condenser, monomer and initiator feeds lines and nitrogen sweep inlet port was added: (335.0 grams) deionized water, a 1.0 wt. % solution based on total monomer (BOM) of 50 wt. % active M-b-cyclodextrin (15.0 grams), a 0.35 wt. % solution (BOM) of sodium carbonate (2.63 grams) and (16.5 grams) deionized water, a 0.4 wt. % solution BOM of ammonium persulfate (3.0 grams) and (20.0 grams) deionized water, and an acrylic seed polymer at 85° C. with overhead stirring set to 255 rpm and a continuous nitrogen sweep to form a reactor heel. To a plastic coated 0.5-gallon glass jar equipped with a magnetic stirrer was added: (270.0 grams) deionized water, 0.25 wt. % BOM FES-32 sodium fatty alcohol ether sulphate sodium fatty alcohol ether sulphate surfactant (BASF, Leverkusen, DE (BASF)), followed by monomer additions in order of descending hydrophobicity: (262.5 grams) lauryl methacrylate (LMA), (262.5 grams) BA, (213.75 grams) MMA and (11.25 grams) MAA and stirring aggressively to form a monomer emulsion. The monomer emulsion was fed into the reactor heel charge using a sub-surface stainless steel feed line over 120 minutes and maintaining 85° C. throughout; a cofeed preparation of 0.1 wt. % BOM of ammonium persulfate (0.75 grams) and (22.5 grams) deionized water was fed simultaneously for the entire 120 minutes of monomer emulsion feed plus a 1-minute overfeed or 121 minutes.

Post feed residual monomer reduction included two shot introductions of a redox package of a 0.15 wt. % solution FeSO₄ (3.45 grams) and isoascorbic acid (IAA, 0.018 grams) and (1.73 grams) deionized water, as a chase activator, and a shot of a 70 wt. % solution of t-butyl hydroperoxide (t-BHP) (0.03 grams) and (1.73 grams) deionized water as the chase catalyst. A Redox pair was prepared with 70 wt. % t-BHP (0.375 grams) and (4.31 grams) deionized water, IAA (0.213 grams) and (4.31 grams) deionized water with both being added in two shots, the first at 60° C. and a 30-minute hold, and 40° C. and a 30-minute hold.

TABLE 1
Materials: Aqueous Emulsion Polymers (AEP)

| Material | Description |
|---|---|
| AEP 1 | Single stage emulsion polymer having carboxylate functional groups, Tg −15 C., |
| | solids 50.5 wt. %, pH 8.9 |
| AEP 2 | Single stage emulsion polymer having carboxylate functional groups, Tg −15 C., |
| | solids 50.7 wt. %, pH 8.5 |
| AEP 3 | RHOPLEX CS-100 styrene-acrylic emulsion polymer, solid content is 45 wt. %, Tg |
| | is 32.3° C.¹, pH is 7.0³, contains Aqua ammonia (28% w/w) <=0.1% (Dow⁴) |
| AEP 4 | Single stage emulsion polymer from 35-part lauryl methacrylate, 35-part butyl |
| | acrylate, 28.5-part methyl methacrylate, and 1.5-part methacrylic acid. Polymer |
| | solids 49.5 wt. %, average particle size 260 nm, Tg: −15.4° C.¹, pH is 7.5 to 8³ |
| AEP 5 | CELVOLIT 1320 vinyl acetate/ethylene latex emulsion polymer, solid content 55.5 |
| | wt. %, Tg is −5.4° C.¹, pH is 3.75³ (Celanese Corporation, Irving TX (Celanese)) |
| AEP 6 | TYLAC 4190 styrene-butadiene emulsion polymer, solids content is 52.5 wt. %, Tg |
| | is −0.5° C.¹, pH is 10.2³, (Mallard Creek Polymers LLC, Charlotte, NC (Mallard |
| | Creek)) |
| AEP 7 | LEASYS 3458 anionic aliphatic polyester-polyurethane dispersion, solids content is |
| | 52.5 wt. %, Tg is ° C. −51.3° C.¹/−50° C.², pH is 8.5³ (Wanhua Chemical Group Co., |
| | Ltd, Yantai, China (Wanhua)) |
| AEP 8 | RHOPLEX AC-261LF all-acrylic emulsion polymer containing carboxylate groups, |
| | solids content is 50 wt. %, Tg is 17.8° C.¹, pH is 9.4² (Dow⁴) |

¹DSC;
²As reported by the manufacturer;
³Measured using pH Tester;
⁴Dow Incorporated, Midland MI.

AEP 1; To form the aqueous emulsion polymer in AEP 1, to the flask having the same flask set up as was used to make AEP 4, was added (330.0 grams) deionized water, a 0.5 wt. % solution based on total monomer (BOM) of sodium carbonate (3.75 grams) and (15.5 grams) deionized water, a 0.4 wt. % solution BOM of ammonium persulfate (3.0 grams) and (20.0 grams) deionized water, and an acrylic seed polymer at 85° C. with an overhead stirrer set to 255 rpm and a continuous nitrogen sweep to form a reactor heel. To a plastic coated 0.5-gallon glass jar equipped with a magnetic stirrer was added: (270.0 grams) deionized water, 0.2 wt. % BOM FES-32 (BASF) anionic surfactant followed by monomer additions in order of descending hydrophobicity: (465.0 grams) 2-EHA, (273.75 grams) MMA and (11.25 grams) MAA, while stirring aggressively to form a monomer emulsion. The monomer emulsion was fed into the reactor heel charge using a sub-surface stainless steel feed line over 120 minutes, maintaining 85° C. throughout; a cofeed preparation of 0.1% BOM of Ammonium Persulfate (0.75 grams) and (22.5 grams) deionized water was fed simultaneously for the entire 120 minutes of monomer emulsion feed plus a 1-minute overfeed or 121 minutes. This reaction was followed by the exact same post feed residual monomer reduction scheme as used in APD4, above.

AEP 2: To form the aqueous emulsion polymer in AEP 2, the method of making AEP 1 was repeated, except the monomers used and their proportions are as stated in Table 1, above.

Formulation Examples: Formulations of stabilized aqueous composition comprising at least one polymer, as shown in Tables 4A and 4B, below, were made as set forth in the following Formulation Examples 1 to 2. Each of Aqueous Coating Formulation 9 (ACF 9), Aqueous Coating Formulation 10 (ACF 10), Aqueous Coating Formulation 11 (ACF 11) was used “as is”.

Formulation Example 1: Aqueous Coating Formulation 12 (ACF12) having pigments and extenders was formulated by placing 250 g of ACF 11 in a flask and adding gradually over a period of 5 min 37.5 g DI water while mixing at 500 rpm for 20 min using an OS40-Pro Overhead Mixer (Scilogex) equipped with a three-arm mixer blade. The total solids content is 36.5 wt. %; the total water content is 63.5 wt. %.

TABLE 2
Other Liquid Phase and Liquid Containing Materials

| Material | Description |
|---|---|
| Base | AMP-95 base, 2-Amino-2-methyl-1-propanol (Sigma-Aldrich Inc., St. Louis MO |
| | (Sigma-Aldrich)) |
| Activator 1 | Al₂(SO₄)₃ 20% w/w aqueous solution |
| Activator 2 | Fe₂(SO₄)₃ |
| Activator 3 | Ca(OH)₂ |
| Activator 4 | CaCl₂ 40% w/w aqueous solution |
| Activator 5 | Fe₂(SO4)₃ 40% w/w aqueous solution |
| Colorant | KEYTEC COLORS B6153 organic colorant, solids content 53% w/w, (uangdong |
| | Keytec New Material Technology Co., Ltd, Guangzhou, China (Keytec Colors)) |
| Coalescing Agent | TEXANOL coalescing agent 2,2,4-Trimethyl-1,3-pentanediol monoisobutyrate, |
| | CAS number 25265-77-4 (Eastman Chemicals, Kingsport, TN (Eastman)) |
| Defoamer 1 | TEGO 1488 organo-modified siloxanes emulsion (Evonik Resource Efficiency |
| | GmbH, Essen, Germany (Evonik)) |
| Defoamer 2 | FOAMASTER MO NXZ (BASF) |
| Dispersant 1 | TAMOL 681 an ammonium salt of a hydrophobic copolymer dispersant in |
| | propylene glycol/water at 35 wt. % solids (Dow Incorporated, Midland, MI (Dow)) |
| Dispersant 2 | TAMOL 731A a sodium salt of a hydrophobic copolymer dispersant composed of |
| | maleic anhydride and diisobutylene in water at 25 wt. % solids (Dow) |
| Dispersant 3 | TAMOL 165A an ammonium salt of a hydrophobic copolymer dispersant |
| | composed of maleic anhydride and diisobutylene in water at 21 wt. % solids |
| | (Dow) |
| Surfactant | TERGITOL 15-S-40 30 wt. % nonionic surfactant with a 15 carbon alkyl group |
| | and 40 ethoxy groups in water (Dow) |

Formulation Example 2: Stabilized aqueous compositions in the form of Aqueous Coating Formulations 13 (ACF13) through 20 (ACF 20) were formulated with the amounts of the indicated materials shown in Table 4B, below, by placing the indicated amount of DI water, in a 1 L flask, and adding into the water the indicated amount of each of the indicated dispersants, surfactants, defoamers and bases, while mixing over a period of 5 min at 500 rpm using a High-Speed Mixer equipped with a dispersion blade to form an aqueous mixture. To the aqueous mixture each of the indicated pigments and extenders was added gradually over a period of 5 min into the aqueous mixture while mixing at 500 rpm using the High-Speed Mixer equipped with a dispersion blade, followed by continued mixing at 1800 rpm for 20 min to form a pigment dispersion. Then to the pigment dispersion, the indicated amount of the indicated aqueous emulsion polymer (AEP) from Table 1, above, and any coalescing solvent was added gradually over a 5 min period while mixing at 500 rpm in an overhead mixer equipped with a three-arm mixer blade, then mixing 20 min at 500 rpm in the overhead mixer.

TABLE 3
Solid Phase Materials

| | |
|---|---|
| Extender | IMSIL-A25 microcrystalline silica, median particle size 5.0 μm (The Cary |
| | Company, Addison, IL (Cary)) |
| Sand 1 | PREMIUM PLAY sand having a particle size of 841 μm (20 mesh), with 100% |
| | having a particle size of 400 μm (40 mesh) or bigger (The Quikrete Companies, |
| | Atlanta, GA (Quikrete)) |
| Sand 2 | PREMIUM PLAY sand having a particle size of 841 μm (20 mesh with <99 or |
| | 100% having a particle size of 177 μm (80 mesh) or bigger (Quikrete) |
| Sand 3 | PREMIUM PLAY sand having a particle size of 400 μm (40 mesh with <99 or |
| | 100% having a particle size of 210 μm (70 mesh) or bigger (Quikrete) |
| GTR Particles | MD-400-TR ground rubber particle having a particle size of 400 μm (40 mesh) |
| | with <99 or 100% having a particle size of 250 μm (60 mesh) or bigger (Lehigh |
| | Technologies, Inc., Tucker, GA (Lehigh Technologies)) |
| Glass Particles | 40/60 GRITS glass bead with >99% having a particle size of 841 μm (20 mesh) |
| | with <99 or 100% having a particle size of 400 μm (40 mesh) or bigger (SilmIm |
| | LLC Charlotte, NC (SilmIm)) |
| Shell Particles | 40/60 walnut shell having a particle size of 400 μm (40 mesh) with <99 or 100% |
| | having a particle size of 250 μm (60 mesh) or bigger (Eco-Shell, LP, Corning, CA |
| | (Eco-Shell)) |
| Pigment 1 | TI-PURE R-706 Titanium Dioxide pigment, median particle size 0.36 μm (The |
| | Chemours Company FC, LLC, Wilmington, DE (Chemours)) |
| Pigment 2 | Lomon R-996 Titanium Dioxide pigment, average particle size 0.23 μm (Sichuan |
| | Lomon Titanium Industry Co, Ltd, Chengdu, China (Lomon)) |

TABLE 4A
Commercial Stabilized Aqueous Compositions Comprising
a Polymer with Pigments and Extenders

| Material | Description |
|---|---|
| ACF 9 | BEHR ULTRA BASE 7753 P170-7 paint, satin, density is 1.10 kg/L, VOC is |
| | 16 g/L, overall solids content is 60.2% w/w, polymer solids content is 17.8%- |
| | 30.7% w/w (PVC 30%~40%)², Tg is −3.2° C.¹, pH is 7.8 (Behr Paint Company, |
| | Santa Ana CA (Behr)) |
| ACF 10 | BEHR ULTRA BASE 7753 P400-7 paint, satin, density is 1.10 kg/L, VOC is |
| | 16 g/L, overall solids content is 60.8% w/w, polymer solids content is 18.0%- |
| | 31.0% w/w (PVC 30%~40%)², Tg is −2.4° C.¹, pH is 8.7 (Behr) |
| ACF 11 | BEHR COTTAGE GARDEN 1850 ULTRA PURE WHITE paint, flat, overall |
| | solids content is 42.0% w/w; polymer solids content is calculated as 10 to 14.7 |
| | wt. % c, Tg is −8.0° C.¹, pH is 8.0 (Behr) |
| ACF 12 | Made from ACF11. See Formulation Example 1, above. Water content 63.5 |
| | wt. % |

¹DSC;
²Calculated in accordance with coating standards.

TABLE 4B
Formulated Stabilized Aqueous Compositions as Coating Formulations

| | Material | | | | | | | | | | |
|---|---|---|---|---|---|---|---|---|---|---|---|
| | | | | | | Additional | | | | | |
| Polymer | Aqueous Mixture | | | | | Ingredient or | | | | | |
| Dispersion | | | Nonionic | | | Pigment Dispersion | | Polymer | Solids Content | | Water |
| (Polymer Tg | Water | Dispersant | Surfactant | Defoamer | Base | Pigment | Extender | AEP | (wt. %) | | Content |
| in ° C.) | (g) | (g) | (g) | (g) | (g) | (g) | (g) | (g) | Total | Polymer | (wt. %) |
| ACF 13 (−5.4) | 119.20 | 1 (15.80) | | 1 (2.40) | 4.00 | 1 (321.90); | (75.80) | 5 (485.60) | 67.3 | 24.7 | 30.9 |
| | | | | | | 2 (67.90) | | | | | |
| ACF 14 (−0.5) | 119.20 | 1 (15.80) | | 1 (2.40) | 4.00 | 1 (321.90); | (75.80) | 6 (485.60) | 65.9 | 23.3 | 32.0 |
| | | | | | | 2 (67.90) | | | | | |
| ACF 15 (−51.3) | 119.20 | 1 (15.80) | | 1 (2.40) | 4.00 | 1 (321.90); | (75.80) | 7 (485.60) | 65.9 | 23.3 | 32.0 |
| | | | | | | 2 (67.90) | | | | | |
| ACF 16 (32.3) | 119.20 | 1 (15.80) | | 1 (2.40) | 4.00 | 1 (321.90); | (75.80) | 3 (485.60) | 62.6 | 20.0 | 35.4 |
| | | | | | | 2 (67.90) | | | | | |
| ACF 17 (32.3) | 665.10 | 1 (15.80) | | 1 (2.40) | 4.00 | 1 (321.90); | (75.80) | 3 (485.60) | 41.8 | 13.3 | 56.9 |
| | | | | | | 2 (67.90) | | | | | |
| ACF 18 (32.3) | 1211.10 | 1 (15.80) | | 1 (2.40) | 4.00 | 1 (321.90); | (75.80) | 3 (485.60) | 31.3 | 10.0 | 67.7 |
| | | | | | | 2 (67.90) | | | | | |
| ACF 19 (17.8) | 198.00 | 3 (47.30) | | 2 (3.6) | 7.2 | 1 (838.10) | | 8 (919.5) | 64.5 | 22.8 | 32.7 |
| ACF 20 (17.8) | 203.28 | 2 (10.5) | 1.6 | 1 (2.94) | | 1 (24.54) | (159.6) | 8 (258.6)¹ | 47 | 19.4 | 49.8 |

¹6.42 g of Coalescing solvent was added.

TABLE 5
Equipment

| Equipment | Model and Source |
|---|---|
| Cellphone | MATE9, Huawei Technologies Co., Ltd., Shenzhen, CN (Huawei) |
| Concrete Mixer (5 GAL) | Humboldt Mfg. Co., Elgin IL, US (Humboldt) |
| DSC | DISCOVERY 2500, TA Instruments-Waters LLC, New Castle, DE, US |
| | (TA) |
| Fluid bed dryer | Model TG-200, Retsch GmbH, Haan DE (Retsch) |
| Glass Slides | Model BS-72P, United Scope LLC, Irvine, CA, US (United Scope) |
| Handheld Mixer | Model FPSBHS0302, Sunbeam Products, Inc., Boca Raton, FL, US |
| | (Sunbeam) |
| High-Speed Mixer | Model 34A62-282, Mixer Direct, Inc., Jeffersonville, IN, US (Mixer |
| | Direct) |
| Hobart Mixer | Model N50, The Hobart Corporation, Troy, OH, US (Hobart) |
| Microscope | AMSCOPE, United Scope |
| Microscope Camera | OMAX A35180U3, United Scope |
| MFFT | MFFT Tester, Biuged Precise Instruments (Guangzhou) Co. Ltd., |
| | Guangzhou, CN (Biuged) |
| Overhead Mixer | OS40-PRO, Scilogex, LLC, Rocky Hill, CT, US (Scilogex) |
| pH Meter | Model HI 5522, Hanna Instruments Inc., Woonsocket, RI, US (Hanna) |
| pH Electrode | PH-9009, Paul N. Gardner Company, Pompano Beach, FL, US (Gardeo) |
| QUV Chamber | QUV-SE, Q-Lab Corp., Westlake, OH, US (Q-Lab) |
| QUV Sample Holder | Q-Lab |
| Reflectance Sensor | NOVOSHADE DUO+, Rhopoint Instruments Ltd., St. Leonards-on-Sea, |
| | UK (Rhopoint) |
| Sieving Machine | AS-200, Retsch |
| Sieve 1 | 841 μm (20 mesh) Retsch |
| Sieve 2 | 400 μm (40 mesh) Retsch |
| Sieve 3 | 250 μm (60 mesh) Retsch |
| Sieve 4 | 177 μm (80 mesh) Retsch |
| Software | IMAGEJ, National Institutes of Health, Bethesda, MD, (NIH) |
| Software | NIX PRO COLOR SENSOR App, Nix |
| Software | OMAX TOUPVIEW, United Scope |
| Software | TRIOS, TA |
| UVA/B Light meter | #UV513AB, General Tools & Instruments LLC, New York, NY, US |
| | (General) |
| UV Light Bulb | UVA340+, Q-Lab |

Example 1: Surface Modified Particles using Aqueous Emulsion Polymers (AEP) and Aqueous Coating Formulations (ACF): Examples 1.1 to 1.24 were prepared with materials and amounts as indicated in Table 6, below. A surface modified sand was prepared in inventive Examples 1.1, 1.2, 1.3, 1.4, 1.5, 1.6, 1.7 and 1.8, by adding 600 g of the indicated sand to a N50 Hobart mixer, followed by adding the indicated activator. The contents were mixed at 143 rpm for 1 minute. The indicated type and amount of ACF was added while mixing at 143 rpm. The contents were mixed for 60 minutes to form a moist mixture. Thereafter, the moist mixture was dried in a fluid bed dryer with a flow rate set at 10 and temperature set at 25° C. for 15 minutes and then at 60° C. for 30 minutes to form a free-flowing surface modified sand.

Comparative Examples 1.10, and 1.11 are repeats of Comparative Example 1.9. In Comparative Examples 1.9, 1.10, 1.11, surface modified sand was prepared by placing 700 g of Sand 1 in the Hobart mixer and adding 35 g of ACF 10 without activator into Sand 1 while mixing for 20 min at 143 rpm to form a moist mixture. Static drying was carried out by first expose the moist mixture under ambient condition for 1 hour, then at 40° C. for 16 hours without agitation. The resulting dried particles were tumbled in a concrete mixer (Humboldt) at 56 rpm for 10 minutes. In Inventive Examples 1.12, 1.13, and 1.14, surface modified sand was prepared in the manner of Comparative Examples 1.9, 1.10, 1.11, except that activator was added to sand before adding ACF 10 while mixing at 143 rpm, and mixing for 1 minute, followed by mixing at 143 rpm for 20 minutes.

Comparative Example 1.15 comprises unmodified sand.

Surface modified sand in Inventive Examples 1.16, 1.17, 1.18, 1.19, 1.20, 1.21, 1.22, 1.23, 1.24 were prepared by placing 100 g of Sand 2 in a 1000 ml container, and adding all at once the indicated amount of Activator 1 into Sand 2 as set forth in Table 6, below, while mixing using the handheld mixer at 890 rpm for 1 minute, then adding all at once the indicated type and amount of an AEP as set forth in Table 6, below, while mixing at 890 rpm. The contents were mixed for 1 minute to form a moist mixture. Thereafter, the moist mixture was dried in a fluid bed dryer at a flow rate set at 10 and a temperature set at 25° C. for 15 min, then at 60° C. for 30 min to form a free-flowing surface modified sand.

The resulting surface modified particles in Examples 1.1 to 1.24 were tested for agglomeration by the sieve test using an 841 μm (20 mesh) Sieve 1. The resulting surface modified particles in Examples 1.1 to 1.15 were also tested by microscopic imaging and particle counting. All of those results are shown in Table 6, below. In Table 6, below, the polymer dispersions in Examples 1.16, 1.17, 1.18, 1.19, 1.20, 1.21, 1.22, 1.23, and 1.24 were transparent when dried so any polymer deposition on surface modified sand could not be determined microscopically.

In Table 6, below, the solids weight % of activator is calculated based on the following equation:

$${P}_{A S} = \frac{{M}_{A} * {S}_{A}}{{M}_{p a r t i c l e}} * 100 ,$$

where P_{AS} is the weight parts of Activator (solids) relative to 100 parts of finely-divided particles, M_{A} is the mass of Activator (wet), S_{A} is the solids wt. % of the Activator, and, M_{particle} is the mass of finely-divided particles that were treated.

In Table 6, below, the solids weight % of AEP or ACF is calculated based on the following equation:

$${P}_{CS} = \frac{{M}_{C} * {S}_{C}}{{M}_{p a r t i c l e}} * 100 ,$$

where P_{CS} is the solids part of an aqueous emulsion polymer (AEP) or an aqueous coating formulation (ACF) relative to 100 parts of finely-divided particles, M_{C} is the mass of AEP or ACF (wet), S_{C} is the solids wt. % of the AEP or ACF, M_{particle} is the mass of finely-divided particles that were treated.

In Table 6, below, the total weight % water is calculated based on the following equation:

$${P}_{T W} = \frac{{M}_{A} * ( 1 - {S}_{A} ) + {M}_{C} * ( 1 - {S}_{C} )}{{M}_{particle}} * 100 ,$$

where P_{TW} is the part of total water relative to 100 parts of finely-divided particles, M_{A} is the mass of Activator, S_{A} is the solids % of the Activator, M_{C} is the mass of the aqueous emulsion polymer (wet), S_{C} is the solids % of the AEP or ACF, M_{particle} is the mass of finely-divided particles.

TABLE 6
Surface Modified Particles Using Aqueous Emulsion Polymers (AEP) and Aqueous Coating Formulations (ACF)

| | | Activator | AEP or ACF | Particle:Activator: | Total Water | | | Sieve | |
|---|---|---|---|---|---|---|---|---|---|
| | | (wt. % based on | (wet wt. % based | AEP and/or ACF | (wt. % based on | Mixing | Drying | Test | Microscopic |
| Example | Particle | wt. dry particle) | on wt. dry particle) | (Solids, w/w/w) | wt. dry particle) | Method | Method | (wt. %) | Imaging |
| 1.1* | Sand 1 | NA (0) | ACF16 (5) | 100:0:3.13 | 1.9 | Hobart | FBD | 100.0 | Fail |
| 1.2* | Sand 1 | NA (0) | ACF16 (10) | 100:0:6.26 | 3.7 | Hobart | NA¹ | 0.0 | Fail |
| 1.3* | Sand 1 | Act.1 (0.4) | ACF18 (10) | 100:0.08:3.13 | 7.2 | Hobart | NA¹ | 0.0 | Fail |
| 1.4* | Sand 1 | Act.1 (0.8) | ACF18 (20) | 100:0.16:6.26 | 14.4 | Hobart | NA¹ | 0.0 | Fail |
| 1.5 | Sand 1 | Act.1 (0.4) | ACF16 (5) | 100:0.08:3.13 | 2.2 | Hobart | FBD | 100.0 | Pass² |
| 1.6 | Sand 1 | Act.1 (0.8) | ACF16 (10) | 100:0.16:6.26 | 4.4 | Hobart | FBD | 100.0 | Pass² |
| 1.7 | Sand 1 | Act.1 (0.4) | ACF17 (7.5) | 100:0.08:3.13 | 4.7 | Hobart | FBD | 99.6 | Pass² |
| 1.8 | Sand 1 | Act.1 (0.8) | ACF17 (15) | 100:0.16:6.26 | 9.4 | Hobart | FBD | 97.6 | Pass² |
| 1.9* | Sand 1 | NA (0) | ACF10 (5) | 100:0:3.04 | 1.96 | Hobart | Static | 1 | Fail |
| 1.10* | Sand 1 | NA (0) | ACF10 (5) | 100:0:3.04 | 1.96 | Hobart | Static | 41 | Fail |
| 1.11* | Sand 1 | NA (0) | ACF10 (5) | 100:0:3.04 | 1.96 | Hobart | Static | 1 | Fail |
| 1.12 | Sand 1 | Act.2 (0.4) | ACF10 (5) | 100:0.4:3.04 | 1.96 | Hobart | Static | 99 | Pass² |
| 1.13 | Sand 1 | Act.3 (0.4) | ACF10 (5) | 100:0.4:3.04 | 1.96 | Hobart | Static | 91 | Pass² |
| 1.14 | Sand 1 | Act.4 (1) | ACF10 (5) | 100:0.4:3.04 | 2.56 | Hobart | Static | 99 | Pass² |
| 1.15* | Sand 2 | NA (0) | NA (0) | 100:0:0 | 0 | NA | NA | 100 | Fail |
| 1.16 | Sand 2 | Act.1 (0.5) | AEP4 (2.5) | 100:0.1:1.24 | 1.66 | Handheld | FBD | 99.9 | ND³ |
| 1.17 | Sand 2 | Act.1 (1) | AEP4 (5) | 100:0.2:2.48 | 3.32 | Handheld | FBD | 99.9 | ND³ |
| 1.18 | Sand 2 | Act.1 (2) | AEP4 (10) | 100:0.4:4.95 | 6.65 | Handheld | FBD | 88.4 | ND³ |
| 1.19 | Sand 2 | Act.1 (0.5) | AEP1 (2.5) | 100:0.1:1.26 | 1.64 | Handheld | FBD | 99.6 | ND³ |
| 1.20 | Sand 2 | Act.1 (1) | AEP1 (5) | 100:0.2:2.53 | 3.27 | Handheld | FBD | 98.6 | ND³ |
| 1.21 | Sand 2 | Act.1 (2) | AEP1 (10) | 100:0.4:5.05 | 6.55 | Handheld | FBD | 88.2 | ND³ |
| 1.22 | Sand 2 | Act.1 (0.5) | AEP2 (2.5) | 100:0.1:1.27 | 1.63 | Handheld | FBD | 99.9 | ND³ |
| 1.23 | Sand 2 | Act.1 (1) | AEP2 (5) | 100:0.2:2.54 | 3.26 | Handheld | FBD | 98.2 | ND³ |
| 1.24 | Sand 2 | Act.1 (2) | AEP2 (10) | 100:0.4:5.07 | 6.53 | Handheld | FBD | 93.2 | ND³ |

*Denotes Comparative Examples.
¹The moist mixtures of Comparative Examples 1.2, 1.3, 1.4 were too wet to be dried with a fluid bed dryer.
²Counting Particles: The surface modified particle has AEP or ACF solids deposited on at least 80% of the particles.
³NOT DETERMINED.
⁴FBD—Fluid bed drier.

As shown in Table 6, above, the surface modified particles of Comparative Examples 1.2, 1.3, 1.4, all with more than 20 times the amount of wet ACF as activator solids, and with more than 20 times the amount of water as activator solids were too wet to be modified with a fluid bed dryer and were too wet for the subsequent sieve test.

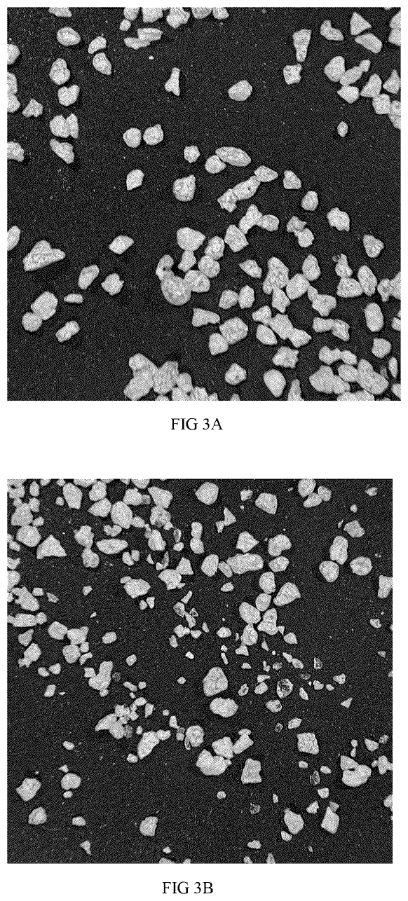

In Inventive Examples 1.5, 1.6, 1.7, and 1.8, even a low amount of activator enabled formation of free-flowing surface modified particles with discrete deposits of coatings with no unbounded fragments; the key to this is limiting total water in the reactive mixture and the use of activators. In Comparative Example 1.1, the low water content relative to total particles the product to pass a sieve test, but with the presence of unbound coating fragments and thus a lack of particle size control. As shown in FIG. 3B, showing magnified images of the product in Comparative Example 1.1, the particles comprise a large portion of unbounded coating fragments. In contrast, as shown in FIG. 3A, the product in inventive Example 1.5 comprises a homogenous composition of surface modified particles having virtually no unbounded coating fragments. Specifically, in FIG. 3A, the Example 1.5, the particle count in the image comprises of 115 particles of the original sieve particle size and no significant amount of unbounded coating fragments. or 96% of free-flowing surface modified particles have at least one discrete deposit of solid material comprising polymer on their surface. And in FIG. 3B, the Comparative Example 1.1, the particles counted in the image comprise 95 particles of the original sieve particle size and 103 undeposited polymer containing fragments.

As shown in Table 6, above, the surface modified particles of inventive Examples 1.12, 1.13 and 1.14 can be made using a variety of activators, including dry Activators 2 and 3. In addition, Activator 2 is a preferred trivalent metal salt of iron and can be used in a smaller amount to greater effect in creating free-flowing surface modified particles. The methods of the present invention are very robust and applicable to a range of compositions of AEPs and ACFs and methods to create free-flowing surface modified particles.

As shown in Table 6 above, fluid bed drying is a preferred drying method as it dries the particles efficiently and all resulting surface modified particles are free-flowing. Inventive Examples 1.16, 1.17, 1.18, 1.19, 1.20, 1.21, 1.22, 1.23 and 1.24 comprise very soft acrylic emulsion polymers having a measured Tg of −15° C. and are expected to be tacky and difficult to process. The stabilized aqueous compositions (emulsion polymers) are all anionically stabilized aqueous emulsion polymers. Even at 5+ wt. % of polymer solids, the inventive Examples 1.18, 1.21 and 1.24 provided free-flowing surface modified particles. Comparative Example 1.15 comprises unmodified sand.

Example 2: Surface modified particles from pre-washed sand particles: Surface modified sand in Inventive Example 2.1 was prepared following the procedure of Example 1.6, above, except using pre-washed Sand 1 instead of Sand 1 as the finely-divided particles. The pre-washed sand was prepared by placing 2 kg of Sand 1 in a 2-gallon bucket, followed by adding 4 kg of tap water and mixing using an overhead mixer (OS40-Pro, SCILOGEX) equipped with a three-arm propeller blade at 400 rpm for 20 minutes, followed by decanting the wash water. The washing process was repeated 5 times after which the moist mixture was dried in a 100° C. oven and cooled to room temperature to yield the pre-washed sand (Pre-washed Sand 1). The resulting of the surface modified sand in Example 2.1 were tested for agglomeration by the sieve test using an 841 μm (20 mesh) Sieve 1. The results are shown in Table 7, below. Surface modified sand in Examples 1.6 and 2.1 were tested for reflectance showing a gain in total reflective as a result of the washing step. The results are shown in Table 8, below.

TABLE 7
Surface Modified Particles From Pre-Washed Sand Particles

| Example | 2.1 |
|---|---|
| Particle | Pre-washed Sand 1 |
| Activator | Act.1 (0.8) |
| (wt. % based on weight of total dry particle) | |
| ACF | ACF16 (10) |
| (wet wt. % based on weight of total dry particle) | |
| Particle:Activator:ACF | 100:0.16:6.26 |
| (Solids, w/w/w) | |
| Total Water (wt. % based on weight of total | 4.4 |
| dry particle) | |
| Mixing Method | Hobart |
| Drying Method | FBD |
| Sieve Test | 99.1 |
| (wt. %) | |
| Microscopic Imaging | Pass¹ |

¹The resulting surface modified particle has coating deposited on at least 80% of the particles and shows no significant amount of undeposited polymer containing particles.

TABLE 8
Reflectance of Surface Modified Sand Particles

| | Unmodified | |
|---|---|---|
| Example | Substrate | Reflectance |
| 1.6 | Sand 1 | 46.2 |
| 2.1 | Pre-washed Sand 1 | 54.2 |

Example 3: Surface Modified Glass Bead, Walnut Shell, GTR, and (Small) Sand Particles The surface modified particles in Examples 3.1 to 3.15 were formed using the materials and amounts indicated in Table 9, below. The resulting products were tested for agglomeration with a sieve test and were imaged via a microscope. The results are shown in Table 9, below. The products of Examples 3.1, 3.2, 3.3, and 3.4 were sieve tested using an 841 μm (20 mesh) Sieve 1, whereas the products of Examples 3.5, 3.6, 3.7, 3.8, 3.9, 3.10, 3.11, 3.12, 3.13, 3.14 and 3.15 were tested for agglomeration with a sieve test using a 400 μm (40 mesh) Sieve 2. The results are shown in Table 9, below.

Surface modified glass bead particles in Examples 3.1, 3.2, 3.3, 3.4 were prepared by placing 100 g of glass particles in a 1000 ml container, and adding Activator 1 while mixing using a handheld mixer set at 890 rpm for 1 minute, then adding the indicated amount of ACF9 while mixing at 890 rpm for 1 minute to form a moist mixture. Thereafter, the moist mixture was dried in a fluid bed dryer (Retsch) with a flow rate set at 10 and a flow temperature set at 25° C. for 15 minutes to form the surface modified glass particles.

Surface modified walnut shell particles in Examples 3.5, 3.6, 3.7, 3.8 were prepared by placing 50 g of shell particles in a 1000 ml container, and the indicated amount of Activator 1 while mixing using a handheld mixer set at 890 rpm for 1 min, then adding the indicated amount of ACF12 while mixing at 890 rpm for 1 minute to form a moist mixture. Thereafter, the moist mixture was dried in a fluid bed dryer with the flow rate set at 10 and the flow temperature set at 25° C. and dried for 15 minutes and then at 60° C. for 30 minutes to form the surface modified walnut shell particles. The resulting products were tested

Surface modified GTR Particles in Examples 3.9, 3.10, 3.11, 3.12 were prepared by placing 50 g of GTR particles in a 1000 ml container, and adding the indicated amount of Activator 1 while mixing using a handheld mixer set at 890 rpm for 1 min, then adding the indicated amount of ACF12, while mixing at 890 rpm for 1 minute to form a moist mixture. Thereafter, the moist mixture was dried in a fluid bed dryer with a flow rate set at 10 and a flow temperature set at 25° C. for 15 minutes and, then drying at 60° C. for 30 minutes to form the surface modified GTR Particles.

The Surface modified sand in Example 3.13, 3.14, 3.15, below was prepared by placing 600 g of Sand 3 having a sieve particle size of 40 to 70 mesh in a Hobart mixer and adding the indicated type and amount of activator into Sand 3 while mixing using the Hobart mixer at 143 rpm for 1 minute, followed by adding the indicated amount of ACF20 containing ACF8, while mixing at 143 rpm for 20 min to form a moist mixture. The moist mixture was then dried in a fluid bed dryer with a flow rate set at 10 and a flow temperature set at 25° C. for 15 minutes and, then drying at 60° C. for 30 min to form a surface modified sand.

Owing to their smoothness and spherical nature, glass particles have a much lower specific surface area than the free-flowing surface modified particles of the present invention and require far less ACF to form the surface modified glass particles made in Examples 3.1, 3.2, 3.3, 3.4. Thus, the proportions of polymer and coating formulation solids and activator are skewed lower than the amounts used to treat sand, silicates, ground rubber particles or ground resins by a factor of more than 1:2. Accordingly, with glass beads, less than half the inventive maximum amount of polymer would be expected to provide excessive polymer solids that may lead to particle agglomeration. Further, the polymer modifier would be expected to cause the glass beads to agglomerate together more easily than in the case of sand, silicates, ground rubber particles or ground resins; and such agglomeration was observed in the FIGS. 1A and 1B showing complex particles made in Comparative Examples 3.1 and 3.2. The activator and the ACF, however, interact in the same way with glass beads as they do with, for example, sand or silicates. Examples 3.3 and 3.4 thus show how the methods of the present invention provide discrete deposits comprising polymer on the surface of each and every particle in the composition. See FIGS. 1C and 1D. Further, the Example 3.4 shows how the methods of the present invention provide compositions comprising solely simple particles, as shown in FIG. 1E.

TABLE 9
Surface Modified Glass Bead, Walnut Shell, GTR, and (Small) Sand Particles

| | | Activator | ACF | Particle: | Total Water | | | Sieve | |
|---|---|---|---|---|---|---|---|---|---|
| | | (wt. % based on | (wet wt. % based | Activator:ACF | (wt. % based on | Mixing | Drying | Test | Microscopic |
| Example | Particle | wt. dry particle) | on wt. dry particle) | (Solids, w/w/w) | wt. dry particle) | Method | Method | (wt. %) | Imaging |
| 3.1* | Glass bead | Act.1 (1) | ACF9 (10) | 100:0.2:6.02 | 4.78 | Handheld | FBD | 67 | Pass² |
| 3.2* | Glass bead | Act.1 (0.5) | ACF9 (5) | 100:0.1:3.01 | 2.39 | Handheld | FBD | 68.9 | Pass² |
| 3.3 | Glass bead | Act.1 (0.25) | ACF9 (2.5) | 100:0.05:1.51 | 1.19 | Handheld | FBD | 89.8 | Pass² |
| 3.4 | Glass bead | Act.1 (0.1) | ACF9 (1) | 100:0.02:0.60 | 0.48 | Handheld | FBD | 99.9 | Pass² |
| 3.5* | Walnut shell | Act.1 (2) | ACF12 (20) | 100:0.4:7.30 | 14.3 | Handheld | FBD | 78.3 | Pass² |
| 3.6 | Walnut shell | Act.1 (1) | ACF12 (10) | 100:0.2:3.65 | 7.15 | Handheld | FBD | 83.5 | Pass² |
| 3.7 | Walnut shell | Act.1 (0.5) | ACF12 (5) | 100:0.1:1.83 | 3.57 | Handheld | FBD | 89.8 | Pass² |
| 3.8 | Walnut shell | Act.1 (02) | ACF12 (2) | 100:0.04:0.73 | 1.43 | Handheld | FBD | 94.6 | Pass² |
| 3.9* | GTR | Act.1 (2) | ACF12 (20) | 100:0.4:7.30 | 14.3 | Handheld | FBD | 61.3 | Pass² |
| 3.10 | GTR | Act.1 (1) | ACF12 (10) | 100:0.2:3.65 | 7.15 | Handheld | FBD | 82.9 | Pass² |
| 3.11 | GTR | Act. 1 (0.5) | ACF12 (5) | 100:0.1:1.83 | 3.57 | Handheld | FBD | 92.7 | Pass² |
| 3.12 | GTR | Act. 1 (02) | ACF12 (2) | 100:0.04:0.73 | 1.43 | Handheld | FBD | 98 | Pass² |
| 3.13* | Sand 3 | NA (0) | ACF20 (12) | 100:0:5.64 | 6.36 | Hobart | NA¹ | 0 | Fail |
| 3.14 | Sand 3 | Act.2 (0.4) | ACF20 (12) | 100:0.4:5.64 | 6.36 | Hobart | FBD | 92 | Pass² |
| 3.15 | Sand 3 | Act.5 (1) | ACF20 (12) | 100:0.4:5.64 | 6.96 | Hobart | FBD | 95 | Pass² |

*Denotes Comparative Examples.
¹The moist mixture of Comparative Example 3.13 was too wet to be dried with a fluid bed dryer.
²The surface modified particle has coating formulation solids deposited on at least 80% of the particles and shows no significant amounts of undeposited fragments comprising polymer.

As shown in Table 9, above, the methods of the present invention enable the provision of free-flowing surface modified particles of a smaller particle size regardless of their chemical makeup, organic or inorganic. The walnut shell particles treated in accordance with the methods of the present invention retained their initial sieve particle size and did not agglomerate, but rather formed surface modified particles having discrete deposits of coating formulation solids on them. The methods are robust and provide economical surface modifying treatments even when the composition has added water in both the aqueous coating formulation and the Activator. Even using a commercial aqueous coating formulation having a composition that is not entirely known, the methods of the present invention reliably provide free-flowing surface modified particles. See Inventive Examples 3.10, 3.11 and 3.12. As shown in Example 3.5, 20 weight parts of ACF12 (˜63.5 wt. % or 12.7 parts water) plus 80 wt. % of a 2 wt. % Activator 1 solution (1.6 weight parts water) solids, or 14.3 wt. % water added to the particles and is above an inventive amount of water. Likewise, the amount of the water in the method of Comparative Example 3.9 is at least 14 wt. % added to the particles.

Example 4: Methods of Treating Recycled Rubber Particles using a Variety of Aqueous Coating Formulations: Surface modified particles as set forth in Table 10, below, were prepared by placing 50 g of ground tire rubber (GTR) particles in a 1000 ml container and adding the indicated amount of Activator 1 into the GTR particles while mixing for 1 min using a handheld mixer set at 890 rpm, and then adding the indicated aqueous coating formulation while mixing at 890 rpm for 1 min to form a moist mixture. Thereafter, the moist mixture was dried in a fluid bed dryer with a flow rate set at 10 and a flow temperature set at 25° C. for 15 minutes to form surface modified particles. The resulting surface modified particles were tested for agglomeration by a sieve test using a 400 μm (40 mesh) Sieve 2; and reflectance. The reflectance results are shown in Table 11.

TABLE 10
Methods of Treating Recycled Rubber Particles using a Variety of Aqueous Coating Formulation

| | | Activator | ACF | Particle: | Total Water | | | Sieve | |
|---|---|---|---|---|---|---|---|---|---|
| | | (wt. % based on | (wet wt. % based | Activator:ACF | (wt. % based on | Mixing | Drying | Test | Microscopic |
| Example | Particle | wt. dry particle) | on wt. dry particle) | (Solids, w/w/w) | wt. dry particle) | Method | Method⁶ | (wt. %) | Imaging |
| 4.1* | GTR | Act. 1 (1) | ACF13 (20)² | 100:0.2:13.5 | 7.3 | Handheld | FBD | 56.7 | Fail |
| 4.2 | GTR | Act. 1 (0.5) | ACF13 (10)² | 100:0.1:6.7 | 3.7 | Handheld | FBD | 73.7 | Fail |
| 4.3 | GTR | Act. 1 (0.25) | ACF13 (5)² | 100:0.05:3.4 | 1.8 | Handheld | FBD | 88.1 | Pass⁵ |
| 4.4* | GTR | Act. 1 (1) | ACF14 (20)³ | 100:0.2:13.2 | 7.6 | Handheld | FBD | 13 | Fail |
| 4.5 | GTR | Act. 1 (0.5) | ACF14 (10)³ | 100:0.1:6.6 | 3.8 | Handheld | FBD | 39.3 | Fail |
| 4.6 | GTR | Act. 1 (0.25) | ACF14 (5)³ | 100:0.05:3.3 | 1.9 | Handheld | FBD | 98.5 | Passs |
| 4.7* | GTR | Act. 1 (1) | ACF15 (20)⁴ | 100:0.2:13.2 | 7.6 | Handheld | FBD | 47.5 | Fail |
| 4.8 | GTR | Act. 1 (0.5) | ACF15 (10)⁴ | 100:0.1:6.6 | 3.8 | Handheld | FBD | 98.1 | Pass⁵ |
| 4.9 | GTR | Act. 1 (0.25) | ACF15 (5)⁴ | 100:0.05:3.3 | 1.9 | Handheld | FBD | 99.0 | Pass⁵ |
| 4.10* | GTR | 0 | 0 | 100:0:0 | 0 | Handheld | FBD | 100 | Fail |

*Denotes Comparative Example.
¹The solids content of aqueous Activator 1 is 20 wt. %.
²The solids content of ACF13 is 67.3 wt. %; the polymer solids content is 22.0 wt. %.
³The solids content of ACF14 is 65.9 wt. %; the polymer solids content is 24.7 wt. %.
⁴The solids content of ACF15 is 65.9 wt.%; the polymer solids content is 23.3 wt. %.
⁵The surface modified particle has coating formulation solids deposited on at least 80% of the finely-divided particles and show no significant amounts of undeposited fragments comprising polymer.
⁶FBD: Fluid Bed Dryer.

TABLE 11
Y-Reflectance of Surface Modified Rubber Particles

| Example | Y-Reflectance |
|---|---|
| 4.1* | 8.9 |
| 4.2 | 4.5 |
| 4.3 | 3.0 |
| 4.4* | 11.9 |
| 4.5 | 8.5 |
| 4.6 | 6.1 |
| 4.7* | 15.2 |
| 4.8 | 10.7 |
| 4.9 | 6.6 |
| 4.10* | 1.2 |

*Denotes Comparative Example.

As shown in Table 10, above, the methods of the present invention enable surface modification of small particles with very soft polymers, such as polyurethane dispersions, which despite their tackiness provide free-flowing surface modified particles even at a 10 wt. % wet coating formulation loading. As shown in Comparative Example 4.10, an activator is needed to provide surface modified particles. In Comparative Examples 4.1, 4.4 and 4.7, the coating formulation and polymer solids exceeds the preferred amount that allows an economical method. As shown in Examples 4.8 and 4.9, a preferred aqueous coating formulation of an acid-functional group containing polyurethane, for example, from dimethylol propionic acid that strongly interact with multivalent metals. In all of the Inventive Examples 4.2, 4.3, 4.5, 4.6, 4.8 and 4.9, the more the coating formulation used, the higher the reflectance in the surface modified black GTR particles. As shown in inventive Examples 4.3, 4.6 and 4.9, 5 wt. % of an aqueous coating formulation (˜1 to 1.5 wt. % polymer solids) provides a preferred polymer proportion in the methods of the present invention. As shown in inventive Examples 4.2 and 4.5, polymers like vinyl acetate ethylene and styrene butadiene that are nonionically stabilized, such as with poly(vinyl alcohol), do not provide an interactive pair with a multivalent metal compound unless they are anionically stabilized.

Example 5: Alternative Processing: Ribbon Mixing: In Example 5.1 surface modified sand was prepared by placing 6000 g of Sand 2 in a CH10 ribbon mixer and adding all at once the indicated amount of Activator 1 as set forth in Table 12, into Sand 2 while mixing at 27 rpm, for Imin, followed by adding gradually over of 5 min the indicated amount of ACF19 as set forth in Table 12, while mixing at 27 rpm, for 60 min to form a moist mixture. Thereafter, the moist mixture was dried in a fluid bed dryer with a flow rate set at 10 and a flow temperature set at 25° C. first for 15 min and then at 60° C. for 30 min to form a surface modified sand. In Comparative Example 5.2 surface modified sand was prepared by placing 4961 g of Sand 2 in the ribbon mixer and adding gradually over the period of 5 min the indicated amount of ACF19 as set forth in Table 12, while mixing at 27 rpm, and mixing for 60 min to form a moist mixture. The moist mixture was too wet to be dried by the fluid bed dryer and form a free-flowing surface modified sand. The resulting products were tested for agglomeration by the sieve test using an 841 μm (20 mesh) Sieve 1. The results are shown in Table 12, below.

TABLE 12
Large Scale Surface Modified Particles by Ribbon mixing

| Example | 5.1 | 5.2* |
|---|---|---|
| Particle | Sand 2 | Sand 2 |
| Activator | Act. 1 (1) | NA (0) |
| (wt. % based on dry particle wt.) | | |
| ACF | ACF19 (12.5) | APD19 (12.5) |
| (wet wt. % based on dry particle wt.) | | |
| Particle:Activator:ACF | 100:0.2:8.1 | 00:08.1 |
| (Solids, w/w/w) | | |
| Total Water (wt. % based on wt. dry | 5.2 | 4.4 |
| particle) | | |
| Mixing Method | Ribbon Mixer | Ribbon Mixer |
| Drying Method | FBD | NA¹ |
| Sieve Test | 97.9 | 0 |
| (wt. %) | | |
| Microscopic Imaging | Pass² | Fail |

*Denotes Comparative Example.
¹The moist mixture of Comparative Example 5.2 was too wet to be fluidized in the fluid bed dryer.
²The surface modified particle has ACF solids deposited on at least 80% of the particle substrate and show no significant amounts of fragments of undeposited ACF solids.

In Comparative Example 5.2, the sand conglomerated into one solid mass and could not be separated from the container. Meanwhile, the surface modified particles of Inventive Example 5.1 comprised free-flowing surface modified particles.

Example 6: Staged surface modified particles: Materials and amounts are set forth in Table 13, below. Surface modified sand in Examples 6.1 and 6.5 was prepared by placing 200.0 g of Sand 1 in a 1000 ml container and adding the indicated amount of Activator 1 into Sand 1 while mixing using a handheld mixer at 890 rpm, for 1 min, then adding the indicated amount of the aqueous coating formulation, while mixing at 890 rpm, for 1 min to form a moist mixture. Thereafter, the moist mixture was dried in a fluid bed dryer with a flow rate set at 10 and an air temperature set at 25° C. for 15 min, and, then drying at 60° C. for 30 min to dry to form a surface modified sand. The surface modified sand in Inventive Examples 6.2, 6.3, and 6.4 was prepared in the manner of Inventive Example 6.1, except that instead of Sand 1, Surface Modified Sand particles were used as substrate particles. The resulting products were tested for agglomeration by the sieve test using an 841 μm (20 mesh) Sieve 1. The results are shown in Table 13, below. The resulting products were also tested for reflectance by the using the Reflectance Test. The results are shown in Table 14, below.

As shown in inventive Examples 6.1, 6.2, 6.3 and 6.4, durable, highly reflective particles that are free-flowing can made with little energy input as heat. Further, in multiple rounds of adding activator and aqueous coating formulation to form a moist mixture and drying, the resulting products have enhanced reflectivity with relatively less polymer surface modifier. A staged process allows more surface modifier whereas a single addition of polymer can result in more agglomeration. Compare the surface modified particles of inventive Example 6.5 with those of inventive Examples 6.2, 6.3 and 6.4.

Example 7: Wetting property of surface modified particles: As shown in a water contact angle (WCA) test result in Table 15, below, all of the surface modified particles in inventive Examples 7.2, 7.3, 7.4, 7.5, 7.6, 7.7, 7.8, 7.9, and 7.10 effectively make the particles water resistant even at low polymer loadings. In Comparative Example 7.1, the finely-divided particle immediately wets the substrate. As shown in Examples 7.3, 7.4, 7.6, 7.7, 7.9 and 7.10, the higher the polymer content in the surface modified particles, the higher the water contact angle and the more hydrophobic the nature of the resulting particles.

TABLE 13
Multiple Stage Surface Modified Particles

| | | Activator | ACF | Particle: | Total Water | | | Sieve | |
|---|---|---|---|---|---|---|---|---|---|
| | | (wt. % based on | (wet wt. % based | Activator:ACF | (wt. % based on | Mixing | Drying | Test | Microscopic |
| Example | Particle | wt. dry particle) | on wt. dry particle) | (Solids, w/w/w) | wt. dry particle) | Method | Method | (wt. %) | Imaging |
| 6.0* | Sand 1 | NA (0) | NA (0) | 100:0:0 | 0 | NA | NA | 100.0 | Fail |
| 6.1 | Sand 1 | Act. 1 (0.4)¹ | ACF16 (5)² | 100:0.08:3.1 | 2.2 | Handheld | FBD | 100.0 | Pass |
| 6.2 | Example 6.1 | Act. 1 (0.4)¹ | ACF 16 (5)² | 100:0.08:3.1 | 2.2 | Handheld | FBD | 99.7 | Pass |
| 6.3 | Example 6.2 | Act. 1 (0.4)¹ | ACF16 (5)² | 100:0.08:3.1 | 2.2 | Handheld | FBD | 99.5 | Pass |
| 6.4 | Example 6.3 | Act. 1 (0.4)¹ | ACF16 (5)² | 100:0.08:3.1 | 2.2 | Handheld | FBD | 99.2 | Pass |
| 6.5 | Sand 1 | Act. 1 (1.6)¹ | ACF16 (20)² | 100:0.32:12.5 | 8.8 | Handheld | FBD | 87.1 | Pass |

*Denotes Comparative Example.
¹The solids content of aqueous Activator 1 is 20 wt. %.
²The solids content of ACF16 is 62.6 wt. %; the polymer solids content is 22.0 wt. %.
³The surface modified particle has polymer deposited on at least 80% of the particles and shows no significant amount of undeposited coating formulation solids or fragments thereof.

TABLE 14
Reflectance of Multiple Stage Surface Modified Particles

| Example | Reflectance |
|---|---|
| 6.0* | 37.0 |
| 6.1 | 50.6 |
| 6.2 | 55.4 |
| 6.3 | 59.2 |
| 6.4 | 58.6 |
| 6.5 | 53.5 |

*Denotes Comparative Example

TABLE 15
Water Contact Angle of surface modified particles

| Example | Particle | WCA¹ (°) |
|---|---|---|
| 7.1* | Example 1.15 | 0 |
| 7.2 | Example 1.16 | 101 |
| 7.3 | Example 1.17 | 112 |
| 7.4 | Example 1.18 | 115 |
| 7.5 | Example 1.19 | 103 |
| 7.6 | Example 1.20 | 111 |
| 7.7 | Example 1.21 | 116 |
| 7.8 | Example 1.22 | 84 |
| 7.9 | Example 1.23 | 101 |
| 7.10 | Example 1.24 | 86 |

*Denotes Comparative Example.
¹Measured immediately after release of the droplet.

Example 8: Adhesion Testing of Surface Modified Particles: Surface modified particles from Example 1, above, were tested for particle asphalt adhesion and at least 4 tests were run, with the average result reported. The test results are shown in Table 16, below.

TABLE 16
Particle Asphalt Adhesion

| Example | Particle | Weight Gain (%) |
|---|---|---|
| 8.1* | Sand 2 | 25.8% |
| 8.2 | Example 1.18 | 42.4%¹ |
| 8.3 | Example 1.21 | 31.3%² |

*Denotes Comparative Example;
¹2.1% std deviation;
²3.8% std. deviation.

As shown in Table 16, above, surface modified particles of the inventive Examples 8.2 and 8.3 exhibit dramatically improved particle adhesion to an asphalt substrate despite comprising 10 wt. % of aqueous emulsion polymer with less than 5 wt. % of polymer solids, based on the weight of the particles.

Example 9: Particle UV Blocking: Sand 2 and various surface modified sands from Example 1 and Example 6, above, were tested for UV transmittance using the UV Blocking Test. The results are shown in Table 17, below. As shown in Table 17, all of the inventive surface modified particles of Examples 9.3, 9.4 and 9.5 provided good to excellent UV blocking. Sand, in Comparative Example 9.2 provided very little UV blocking.

TABLE 17
UV Transmittance

| | | UV Transmittance | UV transmittance |
|---|---|---|---|
| Example | Particle | (mW/cm²) | (%) |
| 9.1* | NA | 6.54 | 100% |
| 9.2* | Sand 2 | 0.20 | 3.06% |
| 9.3 | Example 6.4 | 0.01 | 0.15% |
| 9.4 | Example 1.5 | 0.03 | 0.45% |
| 9.5 | Example 1.6 | 0.01 | 0.15% |

*Denotes Comparative Example.

We claim:

1. A method of forming a plurality of free-flowing surface modified particles comprising:
treating a plurality of dry or anhydrous finely divided particles having a sieve particle size of from 149 to 2000 μm with an aqueous or solid activator chosen from a multivalent metal compound or a flocculant to form activated particles;
mixing the activated particles with a stabilized aqueous composition comprising at least one polymer to form a moist mixture having 10 wt. % or less of water and, further, having from 0.3 to 5.5 wt. %, of polymer as solids, all wt. % s based on the total weight of the dry or anhydrous finely divided particles and all wt. % s adding up to 100%; and,
drying the moist mixture until it forms a composition that is free-flowing, thereby forming free-flowing finely divided particles having thereon discrete deposits of a solid polymer, wherein at least 80 wt. % of the surface modified particles have a sieve particle size no larger than the sieve particle size of the dry or anhydrous finely divided particles.

2. The method as claimed in claim 1, wherein the activator comprises a multivalent metal compound wherein the metal has a valence of 2+ or a valence of 3+.

3. The method as claimed in claim 1, wherein the method does not encapsulate the finely divided particles.

4. The method as claimed in claim 1, further comprising washing the finely-divided particles before treating them with the activator.

5. The method as claimed in claim 1, wherein the activator and the stabilized aqueous composition comprising at least one polymer forms an interactive pair that crosslinks or coagulates the polymer upon mixing them.

6. The method as claimed in claim 5, wherein the interactive pair is chosen from an anionically stabilized aqueous composition comprising at least one polymer and a multivalent metal compound or a nonionically stabilized aqueous composition comprising at least one polymer and a flocculant.

7. The method as claimed in claim 5, wherein the interactive pair is an anionically stabilized aqueous composition comprising at least one polymer and a multivalent metal compound, and the anionically stabilized aqueous composition comprising at least one polymer is an acid-functional group containing emulsion polymer or an aqueous dispersion of a polymer containing an acid-functional group.

8. The method as claimed in claim 5, wherein the stabilized aqueous composition comprising at least one polymer further comprises an additional ingredient chosen from a pigment; a filler; an extender; an adhesion promoter; an antioxidant; an antimicrobial; a waterproofing agent; a compatibilizing agent; an antistatic agent; a biostatic agent; a polymer that confers abrasion resistance; a crosslinking agent, or any two or more thereof.

9. The method as claimed in claim 1, wherein the drying the moist mixture comprises active drying and mixing while continuing to agitate the moist mixture until it is free-flowing.

10. The method as claimed in claim 9, wherein the active drying comprises drying and mixing while heating at a temperature of from 30 to 80° C. and continuing to agitate the moist mixture until it is free flowing.

11. The method as claimed in claim 1, wherein the free-flowing surface modified particles made by the methods of the present invention meet at least one of the following criteria:
(i) the surface modified particle composition comprises 10% or less of polymer particles that are not in the form of deposits on the surface of the particles, based on the total number of particles in the composition, as determined by a visual inspection of a microscopic image of a representative sample of the particles magnified so that the particles have an average diameter of at least 0.4 cm in the image;
(ii) the surface modified particle composition comprises at least 85 wt. % in the form of simple particles, as determined by a visual inspection of a microscopic image of a representative sample of the particles magnified so that the particles have an average diameter of at least 0.4 cm in the image;
(iii) at least 85 wt. % of the surface modified particles has the same sieve particle size as the dry or anhydrous finely divided particles; or,
(iv) at least 95 wt. %, or, preferably, at least 97 wt. % of the free-flowing surface modified particles have at least one discrete deposit of solid material on their surface, as determined by a visual inspection of a microscopic image of a representative sample showing separate particles magnified so that the particles have an average diameter of at least 0.4 cm in the image of the free-flowing surface modified particles have at least one discrete deposit of solid material on their surface.

12. The method as claimed in claim 1, further comprising:
treating a plurality of the free-flowing surface modified particles with an aqueous or solid activator chosen from a multivalent metal compound or a flocculant to form activated particles;
mixing the activated particles with a stabilized aqueous composition comprising at least one polymer to form a moist mixture having 10 wt. % or less of water and, further, having from 0.2 to 5.5 wt. % of polymer solids, all wt. % s based on the total weight of the dry or anhydrous finely divided particles and all wt. % s adding up to 100%; and,
drying the moist mixture until it forms a composition that is free-flowing.

13. The method as claimed in claim 1, wherein the free-flowing surface modified particles made by the methods of the present invention meet at least one of the following criteria:
(i) the surface modified particles exhibit a Water Contact Angle (WCA) of at least 80°, as determined by capturing an image of a vertical cross-section of a 20 μL droplet of a colorant containing aqueous dispersion on the level top surface of a 2 mm thick level packed layer of the surface modified particles and measuring the contact angle using a Java-based image processing program; or,
(ii) a 1 mm thick packed 5 cm by 5 cm layer of the surface modified particles exhibit at least 10% greater 90 degree adhesion to a polymer film, as measured in accordance with ASTM D6862 in comparison to adhesion of a 1 mm thick packed 5 cm by 5 cm layer the same finely divided particles which are not surface modified to the same substrate; or,
(iii) the surface modified particles exhibit enhanced ultraviolet resistance, expressed as an ultraviolet light (UV) transmittance of 2% or less, as determined by measuring the % transmittance of UV energy passing through a 1 mm thick packed layer of the surface modified particles completely covering the sensor hole of a UV chamber equipped with eight UVA340+ UV Light Bulbs and testing at 45° C. and a UV energy level of 0.89 W/m² at 340 nm using a UV513AB UVA/B Light Meter.
